(19) United States
(12) Patent Application Publication
(10) Pub. No.: US 2023/0401427 A1
(43) Pub. Date: Dec. 14, 2023

(54) TRAINING NEURAL NETWORK WITH BUDDING ENSEMBLE ARCHITECTURE BASED ON DIVERSITY LOSS

(71) Applicant: Intel Corporation, Santa Clara, CA (US)

(72) Inventors: Qutub Syed Sha, Munich (DE); Neslihan Kose Cihangir, Munich (DE); Rafael Rosales, Unterhaching (DE)

(73) Assignee: Intel Corporation, Santa Clara, CA (US)

(21) Appl. No.: 18/457,002

(22) Filed: Aug. 28, 2023

Related U.S. Application Data
(60) Provisional application No. 63/488,815, filed on Mar. 7, 2023.

(51) Int. Cl. G06N 3/045

(52) U.S. Cl. CPC G06N 3/045

(57) ABSTRACT

Deep neural networks (DNNs) with budding ensemble architectures may be trained using diversity loss. A DNN may include a backbone and a plurality of heads. The backbone includes one or more layers. A layer in the backbone may generate an intermediate tensor. The plurality of heads may include one or more pairs of heads. A pair of heads includes a first head and a second head duplicated from the first head. The second head may include the same tensor operations as the first head but different internal parameters. The intermediate tensor generated by a backbone layer may be input into both the first head and the second head. The first head may compute a first detection tensor, and the second head may compute a second detection tensor. A similarity between the first detection tensor and the second detection tensor may be used as a diversity loss for training the DNN.

### CROSS REFERENCE TO RELATED APPLICATION

This application claims the benefit of U.S. Provisional Patent Application No. 63/488,815, filed Mar. 7, 2023, which is incorporated by reference in its entirety.

### TECHNICAL FIELD

This disclosure relates generally to deep neural networks (DNNs, also referred to as neural networks), and more specifically, training DNNs with budding ensemble architectures based on diversity loss.

### BACKGROUND

DNNs are used extensively for a variety of artificial intelligence (AI) applications due to their ability to achieve high accuracy. Many DNNs are developed to focus on object detection, e.g., detection and classification of objects in images. With advancements in deep learning technologies, accuracy of DNNs is getting better. DNNs are becoming components of many decision-making pipelines, such as medical diagnosis, object detection, speech recognition, and so on.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example DNN, in accordance with various embodiments.

FIG. 2 is a block diagram of a DNN system, in accordance with various embodiments.

FIG. 3 is a block diagram of a DNN module, in accordance with various embodiments.

FIG. 4 is a block diagram of a DNN with a budding ensemble architecture, in accordance with various embodiments.

FIG. 5 illustrates tensor operations in a DNN with a budding ensemble architecture, in accordance with various embodiments.

FIG. 6 illustrates an example upsampling operation, in accordance with various embodiments.

FIG. 7 illustrates an example concatenation operation, in accordance with various embodiments.

FIG. 8 illustrates an example convolution, in accordance with various embodiments.

FIG. 9 illustrates an example processing element (PE) array, in accordance with various embodiments.

FIG. 10 is a block diagram of a PE, in accordance with various embodiments.

FIG. 11 is a flowchart showing a method of training DNNs with budding ensemble architectures, in accordance with various embodiments.

FIG. 12 is a block diagram of an example computing device, in accordance with various embodiments.

### DETAILED DESCRIPTION

### Overview

The last decade has witnessed a rapid rise in AI based data processing, particularly based on DNNs. DNNs are widely used in the domains of computer vision, speech recognition, image, and video processing mainly due to their ability to achieve beyond human-level accuracy. The significant improvements in DNN model size and accuracy coupled with the rapid increase in computing power of execution platforms have led to the adoption of DNN applications even within resource constrained mobile and edge devices that have limited energy availability.

A DNN layer may include one or more deep learning operations, such as convolution, pooling, elementwise operation, linear operation, nonlinear operation, and so on. A DNN layer may have one or more internal parameters (e.g., weights), which are determined during the training phase. A deep learning operation in the layer may be a tensor operation, i.e., an operation on one or more tensors. A tensor is a data structure having multiple elements across one or more dimensions. Example tensors include a vector, which is a one-dimensional tensor, and a matrix, which is a two-dimensional tensor. There can also be three-dimensional tensors and even higher dimensional tensors. A DNN layer may have an input tensor (also referred to as “input feature map (IFM)”) including one or more input activations (also referred to as “input elements”) and a weight tensor including one or more weights. A weight is an element in the weight tensor. A weight tensor of a convolution may be a kernel, a filter, or a group of filters. The output data of the DNN layer may be an output tensor (also referred to as “output feature map (OFM)”) that includes one or more output activations (also referred to as “output elements”).

Currently available DNNs have limitations such as being unexplainable, overconfident, sensitive to adversarial attacks, and so on. These DNNs typically provide deterministic point estimates with no or generally poor-quality uncertainty estimates. Uncertainty estimation can be crucial for safety-critical tasks such as autonomous driving, medical diagnosis, and so on. Sample-free uncertainty estimation techniques (e.g., ensembles and Gaussian-YoloV3) and sample-based uncertainty estimations (e.g., Bayesian and dropout techniques) have been used to estimate uncertainty of DNN predictions. Sample-free uncertainty estimations are sometimes less preferred as sample-based uncertainty estimations can provide better uncertainty estimation for predictions, including better calibration of its confidence scores.

A well-calibrated model indicates low uncertainty about its prediction when the model is accurate and indicates high uncertainty when it is likely to be inaccurate. Currently available solutions to calibrate deterministic models are mostly based on post-processing techniques. For instance, Sota ensembles require at least 2×parameters compared to deterministic models. The ensembles usually fail to give an opportunity to easily add diversity. The currently available solutions suffer from limitations to train ensembles based on diversity and fail to provide well-calibrated uncertainty estimations.

Embodiments of the present disclosure may improve on at least some of the challenges and issues described above by providing DNNs with budding ensemble architectures. Such DNNs may be trained based on diversity loss functions. The diversity loss functions can also facilitate well-calibrated uncertainty estimation. The DNNs may be deployed for anchor-based object detection tasks.

In various embodiments of the present disclosure, a DNN with a budding ensemble architecture may include a backbone and a plurality of heads. The backbone includes one or more layers. A layer in the backbone may generate an intermediate tensor. The plurality of heads may constitute one or more head ensembles. A head ensemble may be a pair of heads that includes an original head (or “original branch”) and a duplicated head (or “duplicated branch”). The duplicated head may be a duplication of the original head. The duplicated head may include the same types of layers as the original head but different internal parameters. An intermediate tensor generated in a backbone layer may be input into both the original head and the duplicated head.

The DNN may include one or more other head ensembles. Different head ensembles may receive different intermediate tensors generated in different backbone layers. These intermediate tensors may have different sizes. The head ensembles may be arranged in a sequence. Tensors computed in the two heads of a head ensemble may be respectively provided to the two heads of the next head ensemble, and the next head ensemble may use the tensors as well as the intermediate tensor from the backbone to compute outputs. The original head and the duplicated head in a head ensemble may provide two different outputs. The similarity between the two outputs of each head ensemble may be used to define a diversity loss function of the DNN. The diversity loss function may be used to train the DNN.

Compared with currently available techniques, the budding ensemble architectures in the present disclosure provides a better alternative. The budding ensemble architectures can be generalized to various types of DNNs. It has less computational complexity and can perform object detection tasks more accurately and informatively by providing better calibrated uncertainty estimates. It can promote user trust in the predictions made by DNNs.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

### Example DNN Layers

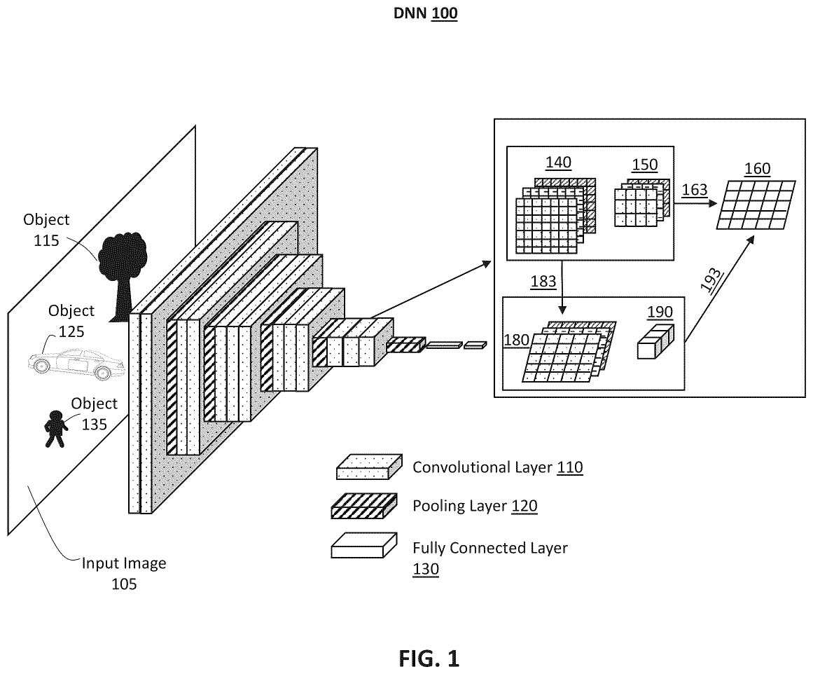

FIG. 1 illustrates an example DNN 100, in accordance with various embodiments. For purpose of illustration, the DNN 100 in FIG. 1 is a CNN. In other embodiments, the DNN 100 may be other types of DNNs. The DNN 100 is trained to receive images and output classifications of objects in the images. In the embodiments of FIG. 1, the DNN 100 receives an input image 105 that includes objects 115, 125, and 135. The DNN 100 includes a sequence of layers comprising a plurality of convolutional layers 110 (individually referred to as “convolutional layer 110”), a plurality of pooling layers 120 (individually referred to as “pooling layer 120”), and a plurality of fully connected layers 130 (individually referred to as “fully connected layer 130”). In other embodiments, the DNN 100 may include fewer, more, or different layers. In an inference of the DNN 100, the layers of the DNN 100 execute tensor computation that includes many tensor operations, such as convolution (e.g., multiply-accumulate (MAC) operations, etc.), pooling operations, elementwise operations (e.g., elementwise addition, elementwise multiplication, etc.), other types of tensor operations, or some combination thereof.

The convolutional layers 110 summarize the presence of features in the input image 105. The convolutional layers 110 function as feature extractors. The first layer of the DNN 100 is a convolutional layer 110. In an example, a convolutional layer 110 performs a convolution on an input tensor 140 (also referred to as IFM 140) and a filter 150. As shown in FIG. 1, the IFM 140 is represented by a 7×7×3 three-dimensional (3D) matrix. The IFM 140 includes 3 input channels, each of which is represented by a 7×7 two-dimensional (2D) matrix. The 7×7 2D matrix includes 7 input elements (also referred to as input points) in each row and 7 input elements in each column. The filter 150 is represented by a 3×3×3 3D matrix. The filter 150 includes 3 kernels, each of which may correspond to a different input channel of the IFM 140. A kernel is a 2D matrix of weights, where the weights are arranged in columns and rows. A kernel can be smaller than the IFM. In the embodiments of FIG. 1, each kernel is represented by a 3×3 2D matrix. The 3×3 kernel includes 3 weights in each row and 3 weights in each column. Weights can be initialized and updated by backpropagation using gradient descent. The magnitudes of the weights can indicate importance of the filter 150 in extracting features from the IFM 140.

The convolution includes MAC operations with the input elements in the IFM 140 and the weights in the filter 150. The convolution may be a standard convolution 163 or a depthwise convolution 183. In the standard convolution 163, the whole filter 150 slides across the IFM 140. All the input channels are combined to produce an output tensor 160 (also referred to as output feature map (OFM) 160). The OFM 160 is represented by a 5×5 2D matrix. The 5×5 2D matrix includes 5 output elements (also referred to as output points) in each row and 5 output elements in each column. For purpose of illustration, the standard convolution includes one filter in the embodiments of FIG. 1. In embodiments where there are multiple filters, the standard convolution may produce multiple output channels in the OFM 160.

The multiplication applied between a kernel-sized patch of the IFM 140 and a kernel may be a dot product. A dot product is the elementwise multiplication between the kernel-sized patch of the IFM 140 and the corresponding kernel, which is then summed, always resulting in a single value. Because it results in a single value, the operation is often referred to as the “scalar product.” Using a kernel smaller than the IFM 140 is intentional as it allows the same kernel (set of weights) to be multiplied by the IFM 140 multiple times at different points on the IFM 140. Specifically, the kernel is applied systematically to each overlapping part or kernel-sized patch of the IFM 140, left to right, top to bottom. The result from multiplying the kernel with the IFM 140 one time is a single value. As the kernel is applied multiple times to the IFM 140, the multiplication result is a 2D matrix of output elements. As such, the 2D output matrix (i.e., the OFM 160) from the standard convolution 163 is referred to as an OFM.

In the depthwise convolution 183, the input channels are not combined. Rather, MAC operations are performed on an individual input channel and an individual kernel and produce an output channel. As shown in FIG. 1, the depthwise convolution 183 produces a depthwise output tensor 180. The depthwise output tensor 180 is represented by a 5×5×3 3D matrix. The depthwise output tensor 180 includes 3 output channels, each of which is represented by a 5×5 2D matrix. The 5×5 2D matrix includes 5 output elements in each row and 5 output elements in each column. Each output channel is a result of MAC operations of an input channel of the IFM 140 and a kernel of the filter 150. For instance, the first output channel (patterned with dots) is a result of MAC operations of the first input channel (patterned with dots) and the first kernel (patterned with dots), the second output channel (patterned with horizontal strips) is a result of MAC operations of the second input channel (patterned with horizontal strips) and the second kernel (patterned with horizontal strips), and the third output channel (patterned with diagonal stripes) is a result of MAC operations of the third input channel (patterned with diagonal stripes) and the third kernel (patterned with diagonal stripes). In such a depthwise convolution, the number of input channels equals the number of output channels, and each output channel corresponds to a different input channel. The input channels and output channels are referred to collectively as depthwise channels. After the depthwise convolution, a pointwise convolution 193 is then performed on the depthwise output tensor 180 and a 1×1×3 tensor 190 to produce the OFM 160.

The OFM 160 is then passed to the next layer in the sequence. In some embodiments, the OFM 160 is passed through an activation function. An example activation function is the rectified linear activation function (ReLU). ReLU is a calculation that returns the value provided as input directly, or the value zero if the input is zero or less. The convolutional layer 110 may receive several images as input and calculate the convolution of each of them with each of the kernels. This process can be repeated several times. For instance, the OFM 160 is passed to the subsequent convolutional layer 110 (i.e., the convolutional layer 110 following the convolutional layer 110 generating the OFM 160 in the sequence). The subsequent convolutional layers 110 perform a convolution on the OFM 160 with new kernels and generates a new feature map. The new feature map may also be normalized and resized. The new feature map can be kernelled again by a further subsequent convolutional layer 110, and so on.

In some embodiments, a convolutional layer 110 has 4 hyperparameters: the number of kernels, the size F kernels (e.g., a kernel is of dimensions F×F×D pixels), the S step with which the window corresponding to the kernel is dragged on the image (e.g., a step of one means moving the window one pixel at a time), and the zero-padding P (e.g., adding a black contour of P pixels thickness to the input image of the convolutional layer 110). The convolutional layers 110 may perform various types of convolutions, such as 2-dimensional convolution, dilated or atrous convolution, spatial separable convolution, depthwise separable convolution, transposed convolution, and so on. The DNN 100 includes 16 convolutional layers 110. In other embodiments, the DNN 100 may include a different number of convolutional layers.

The pooling layers 120 down-sample feature maps generated by the convolutional layers, e.g., by summarizing the presence of features in the patches of the feature maps. A pooling layer 120 is placed between 2 convolution layers 110: a preceding convolutional layer 110 (the convolution layer 110 preceding the pooling layer 120 in the sequence of layers) and a subsequent convolutional layer 110 (the convolution layer 110 subsequent to the pooling layer 120 in the sequence of layers). In some embodiments, a pooling layer 120 is added after a convolutional layer 110, e.g., after an activation function (e.g., ReLU, etc.) has been applied to the OFM 160.

A pooling layer 120 receives feature maps generated by the preceding convolution layer 110 and applies a pooling operation to the feature maps. The pooling operation reduces the size of the feature maps while preserving their important characteristics. Accordingly, the pooling operation improves the efficiency of the DNN and avoids over-learning. The pooling layers 120 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of 2 pixels, so that the pooling operation reduces the size of a feature map by a factor of 2, e.g., the number of pixels or values in the feature map is reduced to one quarter the size. In an example, a pooling layer 120 applied to a feature map of 6×6 results in an output pooled feature map of 3×3. The output of the pooling layer 120 is inputted into the subsequent convolution layer 110 for further feature extraction. In some embodiments, the pooling layer 120 operates upon each feature map separately to create a new set of the same number of pooled feature maps.

The fully connected layers 130 are the last layers of the DNN. The fully connected layers 130 may be convolutional or not. The fully connected layers 130 receive an input operand. The input operand defines the output of the convolutional layers 110 and pooling layers 120 and includes the values of the last feature map generated by the last pooling layer 120 in the sequence. The fully connected layers 130 apply a linear combination and an activation function to the input operand and generate a vector. The vector may contain as many elements as there are classes: element i represents the probability that the image belongs to class i. Each element is therefore between 0 and 1, and the sum of all is worth one. These probabilities are calculated by the last fully connected layer 130 by using a logistic function (binary classification) or a softmax function (multi-class classification) as an activation function.

In some embodiments, the fully connected layers 130 classify the input image 105 and return an operand of size N, where N is the number of classes in the image classification problem. In the embodiments of FIG. 1, N equals 3, as there are 3 objects 115, 125, and 135 in the input image. Each element of the operand indicates the probability for the input image 105 to belong to a class. To calculate the probabilities, the fully connected layers 130 multiply each input element by weight, make the sum, and then apply an activation function (e.g., logistic if N=2, softmax if N>2). This is equivalent to multiplying the input operand by the matrix containing the weights. In an example, the vector includes 3 probabilities: a first probability indicating the object 115 being a tree, a second probability indicating the object 125 being a car, and a third probability indicating the object 135 being a person. In other embodiments where the input image 105 includes different objects or a different number of objects, the individual values can be different.

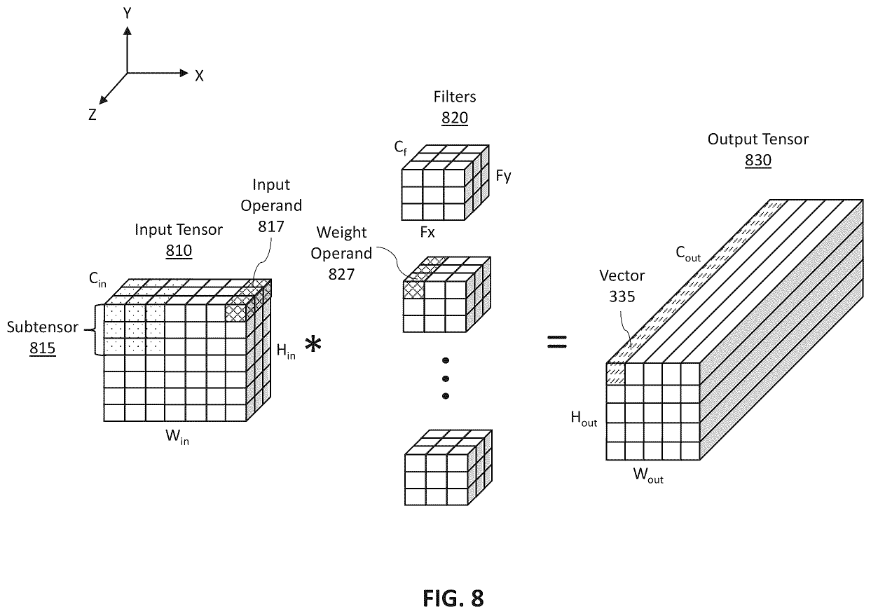

In addition to or alternative to convolution (e.g., standard convolution and depthwise convolution described above or the convolution 800 in FIG. 8), DNNs may include convolution variants, such as transposed convolution, resized convolution, or dilated convolution. A transposed convolution, which may also be referred to as an inverse convolution or transposed convolution, may be a reverse of a convolution. The input of a transposed convolution may be the same as an output of a convolution performed on the output of the transposed convolution. For instance, the IFM 140 may be an output of the transposed convolution, versus the OFM 160 may be an input of the transposed convolution. A resized convolution may include inserting zeros into its input tensor to generate an upsampled tensor and performing a convolution on the upsampled tensor to compute the output tensor of the resized convolution.

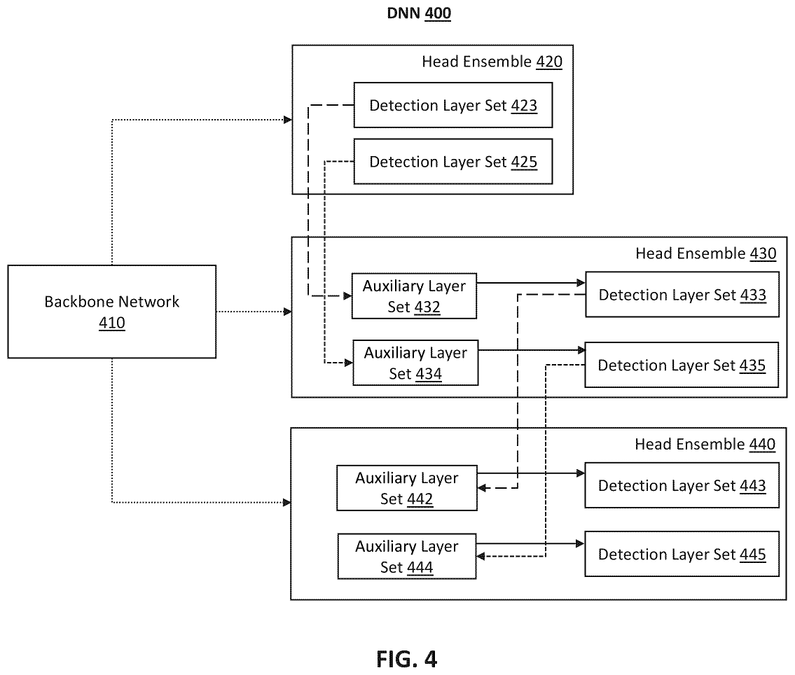

A transposed convolution or resized convolution may be performed by inserting zeros into the input tensor to generate an upsampled tensor and performing a convolution on the upsampled tensor to compute the output tensor. The transposed convolution or resized convolution may have a hyperparameter, e.g., a padding size, that indicates how many zeros to insert or where in the input tensor to insert zeros. The input tensor of a transposed convolution or resized convolution may have a smaller size than the output tensor of the transposed convolution or resized convolution, versus the input tensor of a convolution is usually larger than the output tensor of the convolution. The upsampled tensor may have a larger size than the input tensor of the transposed convolution or resized convolution. More details regarding transposed convolution and resized convolution are provided below in conjunction with FIGS. 4, 5, 6A, and 6B.

A dilated convolution, which may also be referred to as atrous convolution, is another variant of regular convolution. A dilated convolution may expand the kernel by inserting “gaps” between the weights in the kernel. The dilated kernel may be applied on the input tensor to compute the output tensor of the dilated convolution. In the dilated convolution, the gaps in the dilated kernel are not multiplied with activations in the input tensor. The dilation of the kernel can increase the receptive field of the kernel without increasing the number of weights. In some embodiments, a gap may be a value of zero.

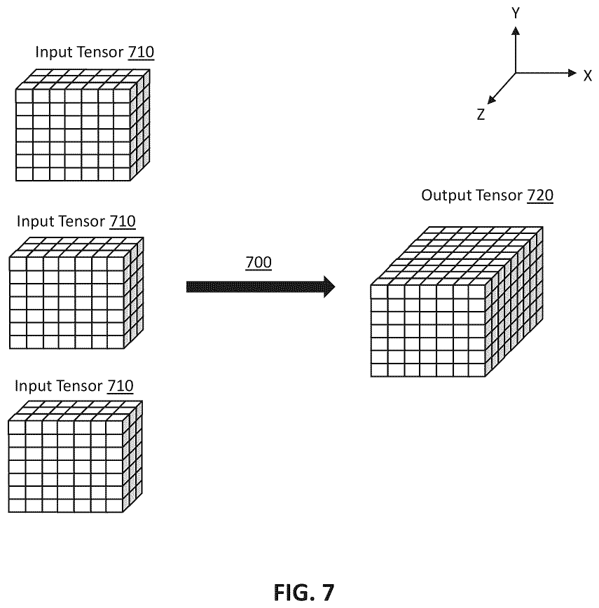

A dilation convolution may have a hyperparameter, e.g., a dilation rate, that indicates how much the kernel is expanded, e.g., how many zero(s) are inserted between two neighboring weights. When the dilation rate is D, the number of zeros inserted between two neighboring weights is D−1. In an example where the dilation rate is one, the dilated convolution reduces to a regular convolution, i.e., no zeros are inserted into the kernel. In another example where the dilation rate is two, a zero may be inserted between any two neighboring weights. For instance, a kernel including four weights may be expanded to a tensor of nine elements that includes the four weights and five zeros. More details regarding transposed convolution and resized convolution are provided below in conjunction with FIGS. 7A and 7B.

### Example DNN System

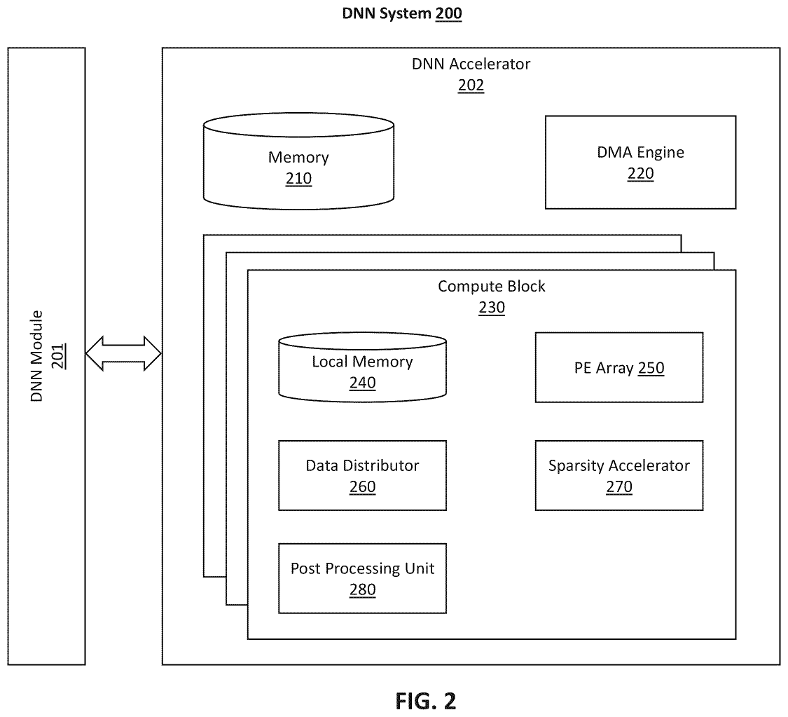

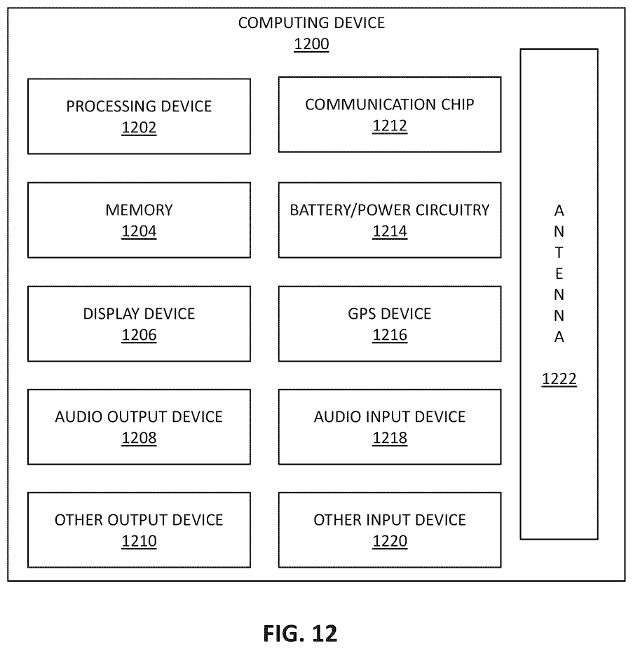

FIG. 2 is a block diagram of a DNN system 200, in accordance with various embodiments. The whole DNN system 200 or a part of the DNN system 200 may be implemented in one or more computing devices, such as the computing device 1200 in FIG. 12. The DNN system 200 can generate and execute DNNs, such as the DNN 100 in FIG. 1, the DNN 400 in FIG. 4, and so on. As shown in FIG. 2, the DNN system 200 includes a DNN module 201 and a DNN accelerator 202. In other embodiments, alternative configurations, different or additional components may be included in the DNN system 200. For instance, the DNN system 200 may include multiple DNN modules or multiple DNN accelerators. Further, functionality attributed to a component of the DNN system 200 may be accomplished by a different component included in the DNN system 200 or a different system. In some embodiments, the DNN module 201 and DNN accelerator 202 may include different types of processing units. The DNN module 201 and DNN accelerator 202 may be implemented in the same chip or separate chips.

The DNN module 201 facilitates generation, training, and deployment of DNNs. In some embodiments, the DNN module 201 may generate and train DNNs. For instance, the DNN module 201 can define the layer architecture of a DNN. The DNN module 201 can also determine the internal parameters (e.g., weights) of the DNN through a DNN training process. The DNN module 201 may further determine one or more hyperparameters that define how the DNN is trained or how one or more deep learning operations in the DNN are to be performed. For instance, hyperparameters may indicate how convolutions or convolutions variants in the DNN are to be performed. Examples of the hyperparameters may include padding size, stride size, kernel size, dilation rate, and so on.

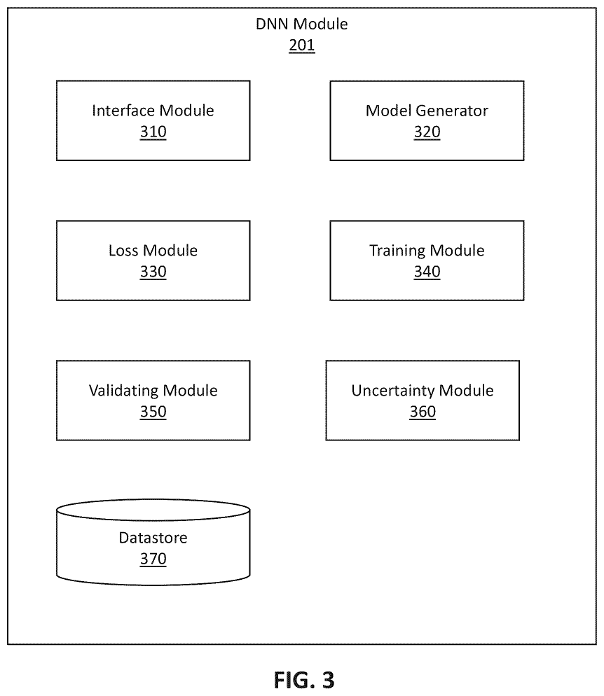

The DNN module 201 may further deploy trained or validated DNNs for use in deep learning applications. In some embodiments, the DNN module 201 may distribute trained or validated DNNs to devices or systems which may use the DNNs to perform tasks (e.g., object detection, image processing, motion planning, etc.) for which the DNNs were trained. In other embodiments, the DNN module 201 may facilitate deployment of the DNNs using the DNN accelerator 202. For instance, the DNN module 201 may receive data from a device or system coupled with the DNN system 200 and input the received data (or data generated by the DNN module 201, e.g., based on the received data) into a DNN. The DNN module 201 may generate instructions (e.g., configuration files) that control the operation of the DNN accelerator 202 during the DNN inference. The DNN module 201 may receive an output of the DNN from the DNN accelerator 202. The DNN module 201 may transmit the output of the DNN (or a result of processing the output of the DNN by the DNN module 201) to the device or system. Certain aspects of the DNN module 201 are provided below in conjunction with FIG. 3.

The DNN accelerator 202 executes DNNs provided by the DNN module 201. For instance, the DNN accelerator 202 can perform DNN inference, e.g., by running deep learning operations in the DNNs, for training DNNs or for using the trained or validated DNNs to perform tasks. As shown in FIG. 2, the DNN accelerator 202 includes a memory 210, a direct memory access (DMA) engine 220, and compute block 230 (individually referred to as “compute block 230”). In other embodiments, alternative configurations, different or additional components may be included in the DNN accelerator 202. For example, the DNN accelerator 202 may include more than one memory 210 or DMA engine 220. As another example, the DNN accelerator 202 may include a single compute block 230. Further, functionality attributed to a component of the DNN accelerator 202 may be accomplished by a different component included in the DNN accelerator 202 or by a different system. A component of the DNN accelerator 202 may be implemented in hardware, software, firmware, or some combination thereof.

The memory 210 stores data associated with deep learning operations (including activation functions) performed by the DNN accelerator. In some embodiments, the memory 210 may store data to be used by the compute blocks 230 for DNN inference. For example, the memory 210 may store data computed by the precompute module 205, such as coefficients of Taylor series. As another example, the memory 210 may store weights, such as weights of convolutional layers, which are determined by training DNNs. The memory 210 may also store data generated by the compute blocks 230 from performing deep learning operations in DNNs. Example deep learning operations include convolutions (also referred to as “convolutional operations”), pooling operations, elementwise operations, activation functions, other types of deep learning operations, or some combination thereof. The memory 210 may be a main memory of the DNN accelerator 202. In some embodiments, the memory 210 includes one or more DRAMs (dynamic random-access memory).

The DMA engine 220 facilitates data transfer between the memory 210 and local memories of the compute blocks 230. For example, the DMA engine 220 can read data from the memory 210 and write data into a local memory of a compute block 230. As another example, the DMA engine 220 can read data from a local memory of a compute block 230 and write data into the memory 210. The DMA engine 220 provides a DMA feature that allows the compute block 230 to initiate data transfer between the memory 210 and the local memories of the compute blocks 230 and to perform other operations while the data transfer is in being conducted. In some embodiments, the DMA engine 220 may read tensors from the memory 210, modify the tensors in a way that is optimized for the compute block 230 before it writes the tensors into the local memories of the compute blocks 230.

The compute blocks 230 can perform deep learning operations in DNNs, including convolution and convolution variants. For instance, a compute block 230 may run a deep learning operation in a DNN layer, or a portion of the deep learning operation, at a time. The compute blocks 230 may be capable of running various types of deep learning operations, such as convolution, pooling, elementwise operation, linear operation, nonlinear operation, and so on. In an example, a compute block 230 may perform convolutions, e.g., standard convolution or depthwise convolution. In some embodiments, the compute block 230 receives an input tensor and one or more convolutional kernels and performs a convolution with the input tensor and convolutional kernels. The result of the convolution may be an output tensor, which can be further computed, e.g., by the compute block 230 or another compute block 230. In some embodiments, the operations of the DNN layers may be run by multiple compute blocks 230 in parallel. For instance, multiple compute blocks 230 may each perform a portion of a workload for a convolution. Data may be shared between the compute blocks 230. A compute block 230 may also be referred to as a compute tile. In some embodiments, each compute block 230 may be a processing unit.

In the embodiments of FIG. 2, each compute block 230 includes a local memory 240, a PE array 250, a data distributor 260, a sparsity accelerator 270, and a post processing unit 280. Some or all the components of the compute block 230 can be implemented on the same chip. In other embodiments, alternative configurations, different or additional components may be included in the compute block 230. Further, functionality attributed to a component of the compute block 230 may be accomplished by a different component included in the compute block 230, a different compute block 230, another component of the DNN accelerator 202, or a different system. A component of the compute block 230 may be implemented in hardware, software, firmware, or some combination thereof.

The local memory 240 is local to the corresponding compute block 230. In the embodiments of FIG. 2, the local memory 240 is inside the compute block 230. In other embodiments, the local memory 240 may be outside the compute block 230. The local memory 240 may store data received, used, or generated by the PE array 250 and the post processing unit 280. Examples of the data may include input activations, weights, output activations, coefficients of Taylor series, results of activation functions, sparsity bitmaps, and so on. Data in the local memory 240 may be transferred to or from the memory 210, e.g., through the DMA engine 220. In some embodiments, data in the local memory 240 may be transferred to or from the local memory of another compute block 230.

In some embodiments, the local memory 240 is one or more static random-access memories (SRAMs). The local memory 240 may be byte-addressable, and each memory address identifies a single byte (eight bits) of storage. In some embodiments, the local memory 240 may include databanks. The number of databanks in the local memory 240 may be 16, 64, 128, 256, 512, 1024, 2048, or other numbers. A databank may include a plurality of storage units. In an example, a databank may include 8, 16, 64, or a different number of storage units. A databank or a storage unit may have one or more memory addresses. In an example, a storage unit may store a single byte, and data larger than a single byte may be stored in storage units with consecutive memory addresses, i.e., adjacent storage units. For instance, a storage unit can store an integer number in the INT8 format, versus two storage units may be needed to store a number in the FP16 or BF16 format, which has 16 bits. In some embodiments, 16 bits can be transferred from the local memory 240 in a single read cycle. In other embodiments, 16 bits can be transferred from the local memory 240 in multiple read cycles, such as two cycles. Certain aspects the local memory 240 are described below in conjunction with FIG. 2C.

The PE array 250 may include PEs arranged in columns, or columns and rows. Each PE can perform MAC operations. In some embodiments, a PE includes one or more multipliers for performing multiplications. An PE may also include one or more accumulators (“adders”) for performing accumulations. A column of PEs is referred to as a PE column. A PE column may be associated with one or more MAC lanes. A MAC lane is a path for loading data into a MAC column. A MAC lane may be also referred to as a data transmission lane or data loading lane. A PE column may have multiple MAC lanes. The loading bandwidth of the MAC column is an aggregation of the loading bandwidths of all the MAC lanes associated with the MAC column. With a certain number of MAC lanes, data can be fed into the same number of independent PEs simultaneously. In some embodiments where a MAC column has four MAC lanes for feeding activations or weights into the MAC column and each MAC lane may have a bandwidth of 16 bytes, the four MAC lanes can have a total loading bandwidth of 64 bytes.

In some embodiments, the PE array 250 may be capable of depthwise convolution, standard convolution, or both. In a depthwise convolution, a PE may perform an MAC operation that includes a sequence of multiplications for an input operand and a weight operand. Each multiplication in the sequence (also referred to as a cycle) is a multiplication of a different activation in the input operand with a different weight in the weight operand. The activation and weight in the same cycle may correspond to the same channel. The sequence of multiplication produces a product operand that includes a sequence of products. The MAC operation may also include accumulations in which multiple product operands are accumulated to produce an output operand of the PE. The PE array 250 may output multiple output operands at a time, each of which is generated by a different PE. In a standard convolution, MAC operations may include accumulations across the channels. For instance, as opposed to generating an output operand, a PE may accumulate products across different channels to generate a single output point.

In some embodiments, the PE array 250 may perform MAC operations in quantized inference, such as MAC operations in a quantized convolution. In some embodiments, a PE in the PE array 250 may receive quantized activation and quantized weights and compute a quantized MAC result. The quantized MAC result may be a quantized value in an integer format and may be the output of the PE. In some embodiments, the PE may also include a quantization multiplier that can multiply a quantization scale with the quantized MAC result, and the output of the PE may be a real value in a floating-point format. The PE may include no quantization subtractors as zero-point offsetting is not needed for the MAC operations in quantized inference.

The data distributor 260 distributes data (e.g., input activations, weights, etc.) of deep learning operations to PEs in the PE array 250 for the PE array 250 to process the data to perform computations in the deep learning operations. The data may be stored in the local memory 240. In some embodiments, the data distributor 260 may be arranged on a data load path from the local memory 240 to the PE array 250.

In some embodiments, the data distributor 260 may distribute data of a deep learning operation to the PEs based on the structures of an input tenor (e.g., the input tensor 810) and one or more weight tensors (e.g., the filters 820) of the deep learning operation. For instance, the input tensor may include a plurality of input channels. A weight tensor may include weights in the input channels. In embodiments where the deep learning operation has multiple output channels (i.e., the output tensor (e.g., the output tensor 830) includes multiple channels), there would be multiple weight tensors, each of which is for one of the output channels. The data distributor 260 may distribute the data based on output channels. In an embodiment, the data distributor 260 may distribute the weight tensors to different PE columns. For instance, each PE column may receive a different weight tensor from the other PE columns. Each of the PE columns may receive the input tensor and perform MAC operations on the input tensor and the corresponding weight tensor.

For a single PE column, the data distributor 260 may partition the input tensor into input operands and partition the weight tensor into weight operands. The data distributor 260 may distribute an input operand (aka “activation operand,” e.g., the input operand 817) and a corresponding weight operand (e.g., the weight operand 827) to a PE in the PE column. The PE may perform a MAC operation on the input operand and weight operand. The data distributor 260 may distribute different input operands/weight operands to the same PE in different computation cycles. In some embodiments, an input operand may include input activations having the same (X, Y) coordinates but in different input channels. Similarly, a weight operand may include input weights having the same (X, Y) coordinates but in different input channels. In an example, an activation in the input operand may be in a different input channel from all the other activations in the input operand, and a weight in the weight operand may be in a different input channel from all the other weights in the weight operand.

The sparsity accelerator 270 accelerates computations in the PE array 250 based on sparsity in activations or weights. For instance, the sparsity accelerator 270 may use sparsity maps generated by the DNN module 201 to accelerate computations in convolution variants. In some embodiments, a computation in a PE may be a MAC operation on an input operand and a weight operand. The input operand may include one or more activations, e.g., activations in an input tensor of a convolution or activations in an upsampled tensor of a convolution variant. Different activations may be in different input channels. The weight operand may include one or more weights, e.g., weights in a filter of a convolution or weights in a dilated filter of a convolution variant. The weights in the weight operand may be in different input channels.

In some embodiments, the input operand is associated with an activation bitmap, which may be stored in the local memory 240. The activation bitmap can indicate positions of the zero-valued activations in the input operand. In an embodiment for performing a transposed or resized convolution, the activation bitmap may indicate positions where zeros are inserted into the input tensor of the transposed or resized convolution. The activation bitmap may include a plurality of bits, each of which corresponds to a respective activation in the input operand. The position of a bit in the activation bitmap may match the position of the corresponding activation in the input operand. A bit in the activation bitmap may be zero or one. A zero-valued bit indicates that the corresponding activation is a zero inserted into the input tensor of the transposed or resized convolution, a one-valued bit indicates that the corresponding activation is an activation in the input tensor of the transposed or resized convolution. An activation bitmap may be a sparsity map generated by the DNN module 201.

In some embodiments, the weight operand is associated with a weight bitmap, which may be stored in the local memory 240. The weight bitmap can indicate positions of the zero-valued weights in the weight operand. In an embodiment for performing a dilated convolution, the weight bitmap may indicate positions where zeros are inserted into the filter of the dilated convolution. The weight bitmap may include a plurality of bits, each of which corresponds to a respective weight in the weight operand. The position of a bit in the weight bitmap may match the position of the corresponding weight in the weight operand. A bit in the weight bitmap may be zero or one. A zero-valued bit indicates that the corresponding weight is a zero inserted into the filter of the dilated convolution to dilate the filter, a one-valued bit indicates that the corresponding weight is a weight in the original filter of the dilated convolution. A weight bitmap may be a sparsity map generated by the DNN module 201.

In some embodiments, the sparsity accelerator 270 may receive the activation bitmap and the weight bitmap and generate a combined sparsity bitmap for the MAC operation to be performed by the PE. In some embodiments, the sparsity accelerator 270 generates the combined sparsity bitmap 735 by performing one or more AND operations on the activation bitmap and the weight bitmap. Each bit in the combined sparsity bitmap is a result of an AND operation on a bit in the activation bitmap and a bit in the weight bitmap, i.e., a product of the bit in the activation bitmap and the bit in the weight bitmap. The position of the bit in the combined sparsity bitmap matches the position of the bit in the activation bitmap and the position of the bit in the weight bitmap. A bit in the combined bitmap corresponds to a pair of activation and weight (activation-weight pair). A zero bit in the combined sparsity bitmap indicates that at least one of the activation and weight was added to the original input tensor or filter for expanding the original input tensor or filter. A one bit in the combined sparsity bitmap indicates that the activation is in the original input tensor and the weight is in the original filter. The combined sparsity bitmap may be stored in the local memory 240.

The sparsity accelerator 270 may provide activations and weights to the PE based on the combined sparsity bitmap. For instance, the sparsity accelerator 270 may identify one or more activation-weight pairs from the local memory 240, each of which corresponds to a one-valued bit in the combined sparsity bitmap. The local memory 240 may store input operands and weight operands in a compressed format so that identified activation-weight pairs are stored but other activation-weight pairs (e.g., one or more activation-weight pairs, each of which corresponds to a zero-valued bit in the combined sparsity bitmap) are not stored.

The identified activation(s) of an input operand may constitute a compressed input operand. The identified weight(s) of a weight operand may constitute a compressed weight operand. The compressed input operand and compressed weight operand may be stored in the local memory 240. In some embodiments, the identified activation(s) and identified weight(s) can be read from the local memory 240 based on the sparsity bitmaps (e.g., the activation bitmap, weight bitmap, the combined bitmap, or some combination thereof) and storage pointers generated by the DNN module 201. A storage pointer may indicate the location where a compressed input operand or a compressed weight operand is stored in the local memory 240. For an identified activation-weight pair, the sparsity accelerator 270 may determine a position the activation in the compressed input operand and determine a position of the weight in the compressed weight operand based on the activation bitmap, weight bitmap, and the combined bitmap. The activation and weight can be read from the local memory 240 based on the positions determined by the sparsity accelerator 270 and the corresponding storage pointer.

The sparsity accelerator 270 may be implemented in hardware, software, firmware, or some combination thereof. In some embodiments, at least part of the sparsity accelerator 270 may be inside a PE. Even though FIG. 4 shows a single sparsity accelerator 270, the compute block 230 may include multiple sparsity modules 450. In some embodiments, every PE in the PE array 250 is implemented with a sparsity accelerator 270 for accelerating computation and reducing power consumption in the individual PE. In other embodiments, a subset of the PE array 250 (e.g., a PE column or multiple PE columns in the PE array 250) may be implemented with a sparsity accelerator 270 for acceleration computations in the subset of PEs.

The post processing unit 280 processes outputs of the PE array 250. In some embodiments, the post processing unit 280 computes activation functions. The post processing unit 280 may receive outputs of the PE array 250 as inputs to the activation functions. The post processing unit 280 may transmit the outputs of the activation functions to the local memory 240. The outputs of the activation functions may be retrieved later by the PE array 250 from the local memory 240 for further computation. For instance, the post processing unit 280 may receive an output tensor of a DNN layer from the PE array 250 and computes one or more activation functions on the output tensor. The results of the computation by the post processing unit 280 may be stored in the local memory 240 and later used as input tensor of the next DNN layer. In addition to or alternative to activation functions, the post processing unit 280 may perform other types of post processing on outputs of the PE array 250. For instance, the post processing unit 280 may apply a bias on an output of the PE array 250.

In some embodiments, the local memory 240 is associated with a load path and a drain path may be used for data transfer within the compute block 230. For instance, data may be transferred from the local memory 240 to the PE array 250 through the load path. Data may be transferred from the PE array 250 to the local memory 240 through the drain path. The data distributor 260 may be arranged on the load path. The post processing unit 280 may be arranged on the drain path for processing outputs of the PE array before the data is written into the local memory 240.

FIG. 3 is a block diagram of the DNN module 201, in accordance with various embodiments. In the embodiments of FIG. 3, the DNN module 201 includes an interface module 310, a model generator 320, a loss module 330, a training module 340, a validating module 350, an uncertainty module 360, and a datastore 370. In other embodiments, alternative configurations, different or additional components may be included in the DNN module 201. Further, functionality attributed to a component of the DNN module 201 may be accomplished by a different component included in the DNN module 201 or a different module or system, such as the DNN accelerator 202.

The interface module 310 facilitates communications of the DNN module 201 with other modules or systems. For example, the interface module 310 establishes communications between the DNN module 201 with an external database to receive data that can be used to train DNNs or input into DNNs to perform tasks. As another example, the interface module 310 supports the DNN module 201 to distribute DNNs to other systems, e.g., computing devices configured to apply DNNs to perform tasks.

The model generator 320 generates DNNs. In some embodiments, the model generator 320 may generate one or more DNNs based on a task. In an example, the model generator 320 may generate DNNs to be used for anchor-based object detection in compute vision. A DNN may receive an image as input and output one or more classifications of each object in the image. Anchor-based object detection may include dividing the image into a grid of cells and placing predefined anchor boxes at various positions within each cell. These anchor boxes may act as reference bounding boxes of different sizes and aspect ratios. The goal is to predict the presence, location, and class of objects within each anchor box. In the process of training the DNN, the anchor boxes may be matched with ground-truth objects based on their overlap or intersection over union (IoU). A positive label may be assigned to an anchor box if it has a high IoU with a ground-truth object, indicating that it should be responsible for detecting that object. An anchor boxes with a low IoU value may be assigned a negative label, indicating that it should not be responsible for any object detection. To make predictions, the DNN may regress the coordinates of the anchor boxes to accurately localize the objects within them. The DNN may also predict the probability of each anchor box containing a specific class of object, e.g., by extracting meaningful features from the input image.

In some embodiments, the model generator 320 may define DNN architectures, including budding ensemble architectures. The model generator 320 may determine what layers to include in a DNN. The model generator 320 may also determine the sequence of the layers. A layer may include one or more deep learning operations. A deep learning operation may be a tensor operation, the input of which is one or more input tensors and the output of which is one or more output tensors. The model generator 320 may determine one or more hyperparameters for a deep learning operation, such as the spatial size of input tensor, the spatial size of output tensor, the spatial size of kernel, other parameters that may be needed to perform the deep learning operation (e.g., padding size, striding size, etc.), or some combination thereof.

In some embodiments, the architecture of a DNN may include one or more input layers, one or more output layers, and one or more hidden layers. In an example where the DNN is to be used for detecting objects in an image, an input layer of the DNN may include a tensor specifying attributes of the image, such as the height of the image, the width of the image, and the depth of the image (e.g., the number of bits specifying the color of a pixel in the input image). An output layer may include classes of one or more objects in the image. The hidden layers are layers between the input layer and output layer. The hidden layers can abstract the image to a feature map, which can be represented by a tensor. Examples of the hidden layers may include convolution layer (e.g., convolutional layer 110 in FIG. 1), pooling layer (e.g., pooling layer 120 in FIG. 1), upsampling layer, concatenation layer, fully connected layer (e.g., fully connected layer 130 in FIG. 1) and so on. In some embodiments, part of the hidden layers may be in a backbone of the DNN, and the rest of the hidden layers may be in one or more heads of the DNN.

The model generator 320 may determine the architecture of a DNN based on the tasks that the DNN will be used for. For instance, the model generator 320 may determine a budding ensemble architecture for a DNN that is to be used to detect objects. An DNN with a budding ensemble architecture may have a backbone network and a plurality of head ensembles. Each head ensemble may include a plurality of heads coupled to the backbone network. In some embodiments, a head ensemble may include two heads, each of which may include one or more detection layers and generate an output tensor indicating classes of one or more objects in the input to the DNN.

In some embodiments, one of the two heads in a head ensemble may be a duplication of the other head. For instance, the two heads may include the same layers arranged in the same sequence. One or more internal parameters of at least one layer in a head may have different value(s) from corresponding internal parameter(s) in the corresponding layer in the other head. The output tensors generated by the two heads may be different, even when the two heads have the same input. In some embodiments, the two heads in a head ensemble may both receive a tensor computed in a layer in the backbone network. The tensor is referred to as an intermediate tensor. In some embodiments (e.g., embodiments where the DNN includes more than one head ensemble), different head ensembles may receive different tensors from the backbone network, such as tensors computed in different layers in the backbone network.

The head ensembles may be arranged in an order. A head ensemble may receive tensors computed in layers in the previous head ensemble. For instance, a head in the head ensemble may receive a tensor computed in a head of the previous head ensemble, while the other head in the head ensemble may receive a tensor computed in the other head of the previous head ensemble. Each head may compute its output tensor based on the intermediate tensor from the backbone network and the tensor from the previous head ensemble. The two output tensors of each head ensemble may be used to determine a diversity loss that can be used to train the DNN.

The loss module 330 determines losses for DNNs, including losses to be used for training the DNNs. In some embodiments, the loss module 330 may determine different types of losses for a DNN and determine a total loss by aggregating the different types of losses. The total loss may be used to train the DNN, e.g., by the training module. For instance, the internal parameters of one or more layers of the DNN may be adjusted to minimize the total loss. The total loss may be denoted as a cost function.

In some embodiments, the loss module 330 may determine losses based on DNN architectures, such as architecture determined by the model generator 320. In an example, the total loss of a DNN with a budding ensemble architecture may be denoted as Lₜₒₜₐₗ:

Lₜₒₜₐₗ=−L_{orig}+λ_{diversity}L_{diveristy}+L_{tandem}

where L_{orig} is an original loss, L_{diveristy} is a diversity loss, λ_{diversity} is the weighting coefficient for the diversity loss, and L_{tandem} is a tandem loss. In other examples, the total loss may include different, fewer, or more components. Also, the original loss or tandem loss may have a weighting coefficient.

The original loss may be denoted as:

L_{orig}=λ_{obj}BCE_{objectness}+λ_{boxes}MSE_{boxes}+λ_{classes}BCE_{classes}

where BCE denotes binary cross entropy loss, and MSE denotes mean square error loss, A denotes the weighting coefficient for each type of losses.

The loss module 330 may determine the diversity loss based on a measurement of similarity between the outputs of the two heads in each head ensemble of the DNN. In some embodiments, the diversity loss may indicate a centered kernel alignment similarity between the outputs of the two heads in a head ensemble. The diversity loss may be denoted as:

$$\begin{matrix}{L}_{diveristy} = CKA ( {O}_{x} , {O}_{y} ) = \frac{HSIC ( {O}_{x} , {O}_{x} )}{\sqrt{HSIC ( {O}_{x} , {O}_{x} ) HSIC ( {O}_{x} , {O}_{x} ) .}} \\ HSIC ( X , Y ) = \frac{t r ( XHYH )}{{( n - 1 )}^{2}} \\ {H}_{n} = {I}_{n} - \frac{1 {1}^{T}}{n}\end{matrix}$$

where CKA denotes centered kernel alignment, Oₓ is the output of the original head in the head ensemble, O_{y} is the output of the duplicated head in the head ensemble, X denotes a kernel of the original head, Y denotes a kernel of the duplicated head, H is the centering matric, and tr is the trace of a matrix.

In other embodiments, the diversity loss may indicate a cosine similarity between the outputs of the two heads in a head ensemble. The diversity loss may be denoted as:

L_{diveristy}=Cosine_{Similarity}(Oₓ,O_{y})

In an embodiment, the cosine similarity between the two output tensors of each head ensemble may be determined across rows of the output tensors. For instance, the similarity between a row in the first output tensor and a corresponding row in the second output tensor may be determined. The position of the row in the first output tensor may match the position of the row in the second output tensor. The similarities across all the rows may be combined to result in the cosine similarity.

In another embodiment, the cosine similarity between the two output tensors of each head ensemble may be determined across columns. For instance, the similarity between a column in the first output tensor and a corresponding column in the second output tensor may be determined. The position of the column in the first output tensor may match the position of the column in the second output tensor. The similarities across all the columns may be combined to result in the cosine similarity.

In yet another embodiment, the cosine similarity between the two output tensors of each head ensemble may be determined across both rows and columns. For instance, the similarity between a 2D matrix in the first output tensor and a corresponding 2D matrix in the second output tensor may be determined. The position of the 2D matrix in the first output tensor may match the position of the 2D matrix in the second output tensor. The similarities across all the 2D matrices may be combined to result in the cosine similarity.

In some embodiments, the loss module 330 may determine a tandem aiding loss and a tandem quelling loss and aggregate the two losses to obtain the tandem loss. The tandem loss L_{tandem} may be denoted as a sum of the tandem aiding loss L_{aiding} and the tandem quelling loss L_{quelling}:

$${L}_{tandem} = {L}_{aiding} + {L}_{quelling}$$

$$\begin{matrix}{L}_{a i d i n g} = M S {E}_{pos\_pred} ( original anchors , duplicate anchors ) \\ = {\sum }_{all branches} \frac{\sum \sqrt[2]{( {O}_{X} - {O}_{Y} ) * p o {s}_{m a s k}}}{2 * \sum p o {s}_{m a s k}}\end{matrix}$$

$$\begin{matrix}{L}_{q u e l l i n g} = {( MS {E}_{n e {g}_{p r e d}} ( original anchors , duplicate anchors ) )}^{- 1} \\ = {\sum }_{all branches} \frac{2 * \sum n e {g}_{m a s k}}{\sum \sqrt[2]{( {O}_{X} - {O}_{Y} ) * n e {g}_{m a s k}}}\end{matrix}$$

where negₘₐₛₖ denotes a negative mask that may be used to identify negative predictions, posₘₐₛₖ denotes a positive mask that may be used to identify positive predictions. The tandem aiding loss may promote agreement between positive predictions when an object is present in the input to the DNN. The tandem quelling loss may promote disagreement between negative predicts when no object is present in the input to the DNN.

The training module 340 trains DNNs by using a training dataset. In some embodiments, the training module 340 may form a training dataset for a DNN. In an example where the training module 340 trains an DNN to recognize objects in images, the training dataset includes training images and training labels. The training labels describe ground-truth classifications of objects in the training images. In some embodiments, each label in the training dataset corresponds to an object in a training image. In some embodiments, a part of the training dataset may be used to initially train the DNN, and the rest of the training dataset may be held back as a validation subset used by the validating module 350 to validate performance of a trained DNN. The portion of the training dataset not including the tuning subset and the validation subset may be used to train the DNN.

The training module 340 also determines hyperparameters for training the DNN. Hyperparameters are variables specifying the DNN training process. Hyperparameters are different from parameters inside the DNN (e.g., weights of filters). In some embodiments, hyperparameters include variables determining the architecture of the DNN, such as number of hidden layers, etc. Hyperparameters also include variables which determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the DNN. An epoch may include one or more batches. The number of epochs may be 3, 30, 300, 300, or even larger.

To train a DNN, the training module 340 inputs a training dataset into the DNN. The training dataset includes a plurality of training samples. The training module 340 may calculate the total loss of the DNN (e.g., a total loss determined by the loss module 330) and modify the parameters inside the DNN to minimize the total loss. The internal parameters include weights of filters in the convolutional layers of the DNN.

The training module 340 may train the DNN for a predetermined number of epochs. The number of epochs is a hyperparameter that defines the number of times that the deep learning algorithm will work through the entire training dataset. One epoch means that each sample in the training dataset has had an opportunity to update internal parameters of the DNN. After the training module 340 finishes the predetermined number of epochs, the training module 340 may stop updating the parameters in the DNN. The DNN having the updated parameters is referred to as a trained DNN.

The validating module 350 verifies accuracy of trained DNNs. In some embodiments, the validating module 350 inputs samples in a validation dataset into a trained DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validating module 350 may determine an accuracy score measuring the precision, recall, or a combination of precision and recall of the DNN. The validating module 350 may use the following metrics to determine the accuracy score: Precision=TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies precision and recall into a single measure.

The validating module 350 may compare the accuracy score with a threshold score. In an example where the validating module 350 determines that the accuracy score of the augmented model is less than the threshold score, the validating module 350 instructs the training module 340 to re-train the DNN. In one embodiment, the training module 340 may iteratively re-train the DNN until the occurrence of a stopping condition, such as the accuracy measurement indication that the DNN may be sufficiently accurate, or a number of training rounds having taken place.

The uncertainty module 360 determines uncertainties of trained DNNs in predictions, such as uncertainties in object detections. In some embodiments, the uncertainty module 360 determines whether an input to a DNN is in distribution or out of distribution. An out-of-distribution (OOD) input dataset may be significantly different from the data that the DNN has been trained on, such as the training dataset formed by the training module 340 to train the DNN. OOD input data may fall outside the distribution of the training data. When the DNN encounters OOD input data during inference or testing, it may struggle to make accurate classifications because it has not been exposed to such data during training. For instance, for a DNN that was trained based on images capturing cats and dogs, an input image that captures a horse may be OOD input data.

In some embodiments, the uncertainty module 360 may determine an OOD uncertainty score (U_{OOD}) to determine whether an input dataset is in distribution or out of distribution. In some embodiments, the uncertainty module 360 may compute the area under the receiver operating characteristic curve (AUROC) based on the U_{OOD} values for both in-distribution and OOD input datasets. The uncertainty module 360 may calculate U_{OOD} using all image detections without discarding any samples.

In some embodiments, (e.g., embodiments where a DNN has a budding ensemble architecture enforced with L_{tandem}), the uncertainty module 360 may use the combination of the mean squared error of bounding box prediction (\hat{x}, ŷ, ŵ, and ĥ), confidence score and entropy from the two heads in each head ensemble without the square root as shown in eq. 7 and eq. 8. The OOD detection performance of the models may be evaluated using two near-OOD datasets U_{near-OOD} and one far-OOD dataset U_{far-OOD}. The higher the AUROC value, the better the OOD detection performance.

$$\begin{matrix}MSE\_bouding box ( z , i , j ) = {( {\hat{z}}_{i j}^{α} - {\hat{z}}_{i j}^{β} )}^{2} \\ MSE\_bouding {box}_{O O D} ( z , s , b ) = {\sum }_{z ∈ ( \hat{x} , \hat{y} , \hat{w} , \hat{h} , \hat{C} )} MSE\_bounding box ( z , s , b ) \\ H ( X ) = - {\sum }_{i = 1}^{n} p ( {x}_{i} ) ln ( p ( {x}_{i} ) ) \\ MSE\_entropy ( z , i , j ) = {( H ( {\hat{z}}_{i j}^{α} ) - H ( {\hat{z}}_{i j}^{β} ) )}^{2} \\ {MSE\_entropy}_{OOD} ( z , s , b ) = \sqrt{{\sum }_{z ∈ ( \hat{x} , \hat{y} , \hat{w} , \hat{h} , \hat{C} )} MSE\_entropy ( z , s , b )} \\ {U}_{O O D} = {MSE\_bbox}_{O O D} ( z , s , b ) \times {MSE\_entropy}_{OOD} ( z , s , b )\end{matrix}$$

where s∀S and b∀B, a indicates the original head in a head ensemble, and β indicates the duplicated head.

In some embodiments, after one or more OOD input datasets are detected, the uncertainty module 360 may request the training module 340 to re-train the DNN. For instance, the uncertainty module 360 may request the training module 340 to form a new training dataset, which can make the one or more input dataset to be in distribution, such as training dataset including objects that are included in the one or more input dataset. The training module 340 may further train the DNN with the new training dataset. The uncertainty module 360 may determine whether the one or more input datasets are still out of distribution for the retrained DNN. Additionally or alternatively, the uncertainty module 360 may prohibit the DNN from being deployed for the one or more input datasets to avoid unreliable object detections. Also, the uncertainty module 360 may generate a message informing a user of the DNN that the one or more input data are out of distribution.

In some embodiments, the uncertainty module 360 estimates uncertainty errors of trained DNNs. In some embodiments, the uncertainty module 360 may use an uncertainty error metric to evaluate a DNN's ability to accept correct detections and reject incorrect. The uncertainty error UE may be denoted as:

$$\begin{matrix}UE = \frac{T P R j + F P R t}{2} \\ TPRj = \frac{\vert U ( D c ) > δ \vert}{\vert Dc \vert} \\ PRt = \frac{\vert U ( D i ) \leq δ \vert}{\vert Di \vert}\end{matrix}$$

where TPRj denotes True Positive Rejection, which is a proportion of correct detections Dc that are incorrectly rejected; FPRt denotes False Positive Retention, which is a proportion of incorrect detections Dᵢ that are incorrectly accepted; and δ denotes an uncertainty estimate threshold. The uncertainty module 360 may determine the uncertainty estimate threshold based on a minimum uncertainty error that would be ideal for separating correct and incorrect detections.

Ideally, an uncertainty error may be 0% where all Dᵢ are rejected and all De are accepted. Both TPRj and FPRt may be given equal weightage in some embodiments. The confidence score of a DNN with a budding ensemble architecture may be calibrated by using tandem loss L_{tandem}, the overall uncertainty of a predicted object U_{pred} can be directly inferred as the compliment of the confidence score Ĉ:

U_{pred}=1−Ĉ

The datastore 370 stores data received, generated, used, or otherwise associated with the DNN module 201. For example, the datastore 370 stores the datasets used by the training module 340 and validating module 350. The datastore 370 may also store data generated by the training module 340 and validating module 350, such as the hyperparameters for training DNNs, internal parameters of trained DNNs (e.g., weights, etc.), data for sparsity acceleration (e.g., sparsity bitmap, etc.), and so on. In the embodiment of FIG. 3, the datastore 370 is a component of the DNN module 201. In other embodiments, the datastore 370 may be external to the DNN module 201 and communicate with the DNN module 201 through a network.

### Example Budding Ensemble Architecture

FIG. 4 is a block diagram of a DNN 400 with a budding ensemble architecture, in accordance with various embodiments. The DNN may be used for computer vision, e.g., for detecting objects captured by sensors, such as cameras or other types of sensors. The DNN 400 may be generated, trained, validated, or deployed by the DNN module 201. As shown in FIG. 4, the DNN 400 includes a backbone network 410 and three head ensembles 420, 430, and 440. The three head ensembles 420, 430, and 440 may be arranged after the backbone network 410. In other embodiments, the DNN 400 may include different, fewer, or more components. For instance, the DNN 400 may include a different number of head ensembles.

The backbone network 410 includes a plurality of backbone layers, such as the layers shown in FIG. 1. The backbone layers may be for one or more types of deep learning operations, such as convolution, pooling, activation function, elementwise operation, and so on. In some embodiments, the backbone network 410 may have an input layer and a plurality of hidden layers. The input layer receives an input to the DNN 400, such as an image or other types of input. The hidden layers may compute intermediate tensors based on the input and internal parameters (e.g., weights) of the hidden layers. The backbone network 410 is coupled to the head ensembles 420, 430, and 440. Intermediate tensors generated by backbone layers in the backbone network 410 may be input into the head ensemble 420, 430, and 440 for further computations.

The head ensemble 420 may include a detection layer set 423 and a detection layer set 425. Each of the detection layer set 423 and the detection layer set 425 includes one or more detection layers that can generate an output of the DNN 400. The output of the DNN 400 may include one or more classifications of an object. In some embodiments, the detection layer set 425 is a duplication of the detection layer set 423. For instance, the detection layer set 425 may have the same detection layers, which may be arranged in the same sequence, as the detection layer set 423. At least one detection layer in the detection layer set 423 may have different internal parameters (e.g., weights) from the corresponding detection layer in the detection layer set 425. The output of the detection layer set 423 would be different from the detection layer set 425, even when the input to the first set is the same as the input to the second set.

In some embodiments, the detection layer set 423 and the detection layer set 425 may have the same input tensor. The input tensor may be an intermediate tensor generated in a layer in the backbone network 410. In an example, the layer in the backbone network 410 may be the last layer of the backbone network 410. The intermediate tensor may be input into the first detection layer in the detection layer set 423 and the first detection layer in the detection layer set 425. The intermediate tensor may go through the same types of deep learning operations in the detection layer set 423 and the detection layer set 425, but the deep learning operations in the detection layer set 423 may have different weights from the detection layer set 425.

The head ensemble 430 includes an auxiliary layer set 432, a detection layer set 433, another auxiliary layer set 434, and another detection layer set 435. Each of the auxiliary layer set 432 and the auxiliary layer set 434 includes one or more auxiliary layers, such as upsampling layer, concatenation layer, convolution layer, other types of layers, or some combination thereof. In some embodiments, the auxiliary layer set 434 is a duplication of the auxiliary layer set 434. For instance, the auxiliary layer set 434 may have the same sequence of auxiliary layers (or the same types of deep learning operations) as the auxiliary layer set 432, but at least one auxiliary layer in the auxiliary layer set 434 may have different internal parameters (e.g., weights) from the corresponding auxiliary layer in the auxiliary layer set 432.

Each of the detection layer set 433 and the detection layer set 435 includes one or more detection layers. The detection layer set 435 may be a duplication of the detection layer set 433. The detection layer set 435 may have the same sequence of detection layers (or the same types of deep learning operations) as the detection layer set 433, but at least one detection layer in the detection layer set 435 may have different internal parameters (e.g., weights) from the corresponding detection layer in the detection layer set 435. In some embodiments, the detection layers in the detection layer set 433 or 435 are different from the detection layers in the detection layer set 423 or 425. For instance, the detection layer set 433 or 435 may include one or more different, fewer, or more detections layers from the detection layer set 423 or 425. Additionally or alternatively, detection layers in the detection layer set 433 or 435 may be arranged in a different sequence from the detection layer set 423 or 425.

In some embodiments, the auxiliary layer set 432 and the auxiliary layer set 434 may have the same input, which may be an intermediate tensor generated in a layer in the backbone network 410. This intermediate tensor may be different from the intermediate tensor input into the head ensemble 420. For instance, the intermediate tensor may be generated by a different layer in the backbone network 410. In some embodiments, an auxiliary layer in the auxiliary layer set 432 may receive an output of a detection layer (“a detection tensor”) in the detection layer set 423. The auxiliary layer set 432 may output an auxiliary tensor based on the detection tensor from the detection layer set 423 and the intermediate tensor from the backbone network 410. The auxiliary tensor may be input into the detection layer set 433 for further computations. Similarly, the auxiliary layer set 434 may output another auxiliary tensor based on a detection tensor from the detection layer set 425 and the intermediate tensor from the backbone network 410. The auxiliary tensor may be input into the detection layer set 435 for further computations. The detection layer set 433 and the detection layer set 435 may generate two outputs of the DNN 400. An output may include one or more classifications of an object. The two outputs may be different.

The head ensemble 440 includes an auxiliary layer set 442, a detection layer set 443, another auxiliary layer set 444, and another detection layer set 445. Each of the auxiliary layer set 442 and the auxiliary layer set 444 includes one or more auxiliary layers, such as upsampling layer, concatenation layer, convolution layer, other types of layers, or some combination thereof. In some embodiments, the auxiliary layer set 444 is a duplication of the auxiliary layer set 444. For instance, the auxiliary layer set 444 may have the same sequence of auxiliary layers (or the same types of deep learning operations) as the auxiliary layer set 442, but at least one auxiliary layer in the auxiliary layer set 444 may have different internal parameters (e.g., weights) from the corresponding auxiliary layer in the auxiliary layer set 442.

Each of the detection layer set 443 and the detection layer set 445 includes one or more detection layers. The detection layer set 445 may be a duplication of the detection layer set 443. The detection layer set 445 may have the same sequence of detection layers (or the same types of deep learning operations) as the detection layer set 443, but at least one detection layer in the detection layer set 445 may have different internal parameters (e.g., weights) from the corresponding detection layer in the detection layer set 445. In some embodiments, the detection layers in the detection layer set 443 or 445 are different from the detection layers in the detection layer set 423 or 425. For instance, the detection layer set 443 or 445 may include one or more different, fewer, or more detections layers from the detection layer set 423 or 425. Additionally or alternatively, detection layers in the detection layer set 443 or 445 may be arranged in a different sequence from the detection layer set 423 or 425.

In some embodiments, the auxiliary layer set 442 and the auxiliary layer set 444 may have the same input, which may be an intermediate tensor generated in a layer in the backbone network 410. This intermediate tensor may be different from the intermediate tensor input into the head ensemble 420 or from the intermediate tensor input into the head ensemble 430. For instance, the intermediate tensor may be generated by a different layer in the backbone network 410. In some embodiments, an auxiliary layer in the auxiliary layer set 442 may receive a detection tensor in the detection layer set 433. The auxiliary layer set 442 may output an auxiliary tensor based on the detection tensor from the detection layer set 433 and the intermediate tensor from the backbone network 410. The auxiliary tensor may be input into the detection layer set 443 for further computations. Similarly, the auxiliary layer set 444 may output another auxiliary tensor based on a detection tensor from the detection layer set 435 and the intermediate tensor from the backbone network 410. The auxiliary tensor may be input into the detection layer set 445 for further computations. The detection layer set 443 and the detection layer set 445 may generate two outputs of the DNN 400. An output may include one or more classifications of an object. The two outputs may be different.

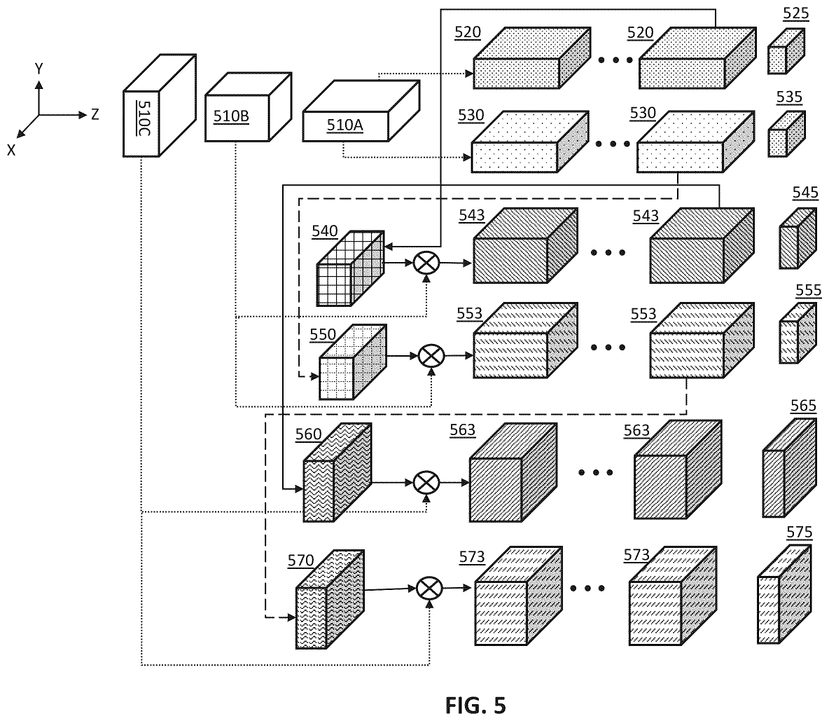

FIG. 5 illustrates tensor operations in a DNN with a budding ensemble architecture, in accordance with various embodiments. An example of the DNN may be the DNN 400 in FIG. 4. In the embodiments of FIG. 5, three intermediate tensors 510A, 510B, and 510C are selected. These three intermediate tensors 510A, 510B, and 510C may be computed in three different layers of the backbone of the DNN. As shown in FIG. 5, the intermediate tensors 510A, 510B, and 510C have different spatial sizes from each other. In other embodiments, two or three of the intermediate tensors 510A, 510B, and 510C may have the same spatial size.

The intermediate tensors 510A, 510B, and 510C may be input into three different head ensembles of the DNN. The intermediate tensor 510A is input into a head ensemble including a first head and a second head. The first head includes detection layers that output detection tensors 520 (individually referred to as “detection tensor 520”). The first head outputs an output of the DNN, i.e., a tensor 525. The tensor 525 may be computed based on the detection tensor 520 generated by the last detection layer. The second head, which may be a duplication of the first head, includes detection layers that output detection tensors 530 (individually referred to as “detection tensor 530”). The second head outputs another output of the DNN, i.e., a tensor 535. The tensor 535 may be computed based on the detection tensor 530 generated by the last detection layer. The tensors 525 and 535 may have the same spatial size. In some embodiments, the data elements in the tensors 525 and 535 may have different values.

The intermediate tensor 510B is input into another head ensemble including a third head and a fourth head, which may be a duplication of the third head. In addition to the intermediate tensor 510B, the third head also receives a detection tensor 520, while the fourth head also receives a detection tensor 530. In the third head, the detection tensor 520 is converted to a tensor 540, e.g., through upsampling operation and convolution. The tensor 540 and the intermediate tensor 510B are processed, e.g., through concatenation and convolution, to compute an input of one or more detection layers in the third head. Each detection layer in the third head may compute a detection tensor 543. The third head outputs an output of the DNN, i.e., a tensor 545. The tensor 545 may be computed based on the detection tensor 543 generated by the last detection layer.

In the fourth head, the detection tensor 530 is converted to a tensor 550, e.g., through upsampling operation and convolution. The tensor 550 and the intermediate tensor 510B are processed, e.g., through concatenation and convolution, to compute an input of one or more detection layers in the fourth head. Each detection layer in the fourth head may compute a detection tensor 553. The fourth head outputs an output of the DNN, i.e., a tensor 555. The tensor 555 may be computed based on the detection tensor 553 generated by the last detection layer. The tensors 545 and 555 may have the same spatial size, which may be different from the spatial size of the tensor 525 or 535. In some embodiments, the data elements in the tensors 545 and 555 may have different values.

The intermediate tensor 510C is input into yet another head ensemble including a fifth head and a sixth head, which may be a duplication of the fifth head. In addition to the intermediate tensor 510B, the fifth head also receives a detection tensor 543, while the sixth head also receives a detection tensor 553. In the fifth head, the detection tensor 543 is converted to a tensor 560, e.g., through upsampling operation and convolution. The tensor 560 and the intermediate tensor 510C are processed, e.g., through concatenation and convolution, to compute an input of one or more detection layers in the fifth head. Each detection layer in the fifth head may compute a detection tensor 563. The fifth head outputs an output of the DNN, i.e., a tensor 565. The tensor 565 may be computed based on the detection tensor 563 generated by the last detection layer.

In the sixth head, the detection tensor 553 is converted to a tensor 570, e.g., through upsampling operation and convolution. The tensor 570 and the intermediate tensor 510C are processed, e.g., through concatenation and convolution, to compute an input of one or more detection layers in the sixth head. Each detection layer in the sixth head may compute a detection tensor 573. The sixth head outputs an output of the DNN, i.e., a tensor 575. The tensor 575 may be computed based on the detection tensor 573 generated by the last detection layer. The tensors 565 and 575 may have the same spatial size, which may be different from the spatial size of the tensor 525 or 535. In some embodiments, the data elements in the tensors 565 and 575 may have different values.

In some embodiments, the tensors 525, 535, 545, 555, 565, and 575 may have different spatial sizes. For example, the dimensions of the tensors 525, 535, 545, 555, 565, and 575 along the X axis may be different. Additionally or alternatively, the dimensions of the tensors 525, 535, 545, 555, 565, and 575 along the Y axis may also be different. In some embodiments, the tensors 525, 535, 545, 555, 565, and 575 may have the same dimension along the Z axis. The dimension along the Z axis may indicate the numbers of channels. The number of channels in the tensors 525, 535, 545, 555, 565, and 575 may depend on the number of classes into which the DNN classifies objects. In an example, the number of channels in the tensors 525, 535, 545, 555, 565, and 575 may be denoted as:

C=B×(4+1+N)

where B denotes the number of prior anchors, and N denotes the number of classes.

### Example Upsampling Operation

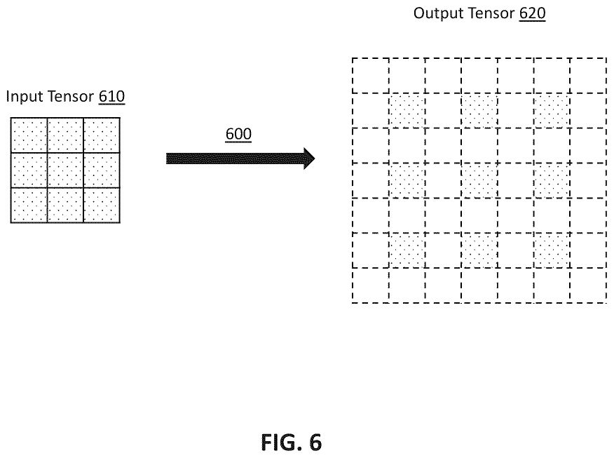

FIG. 6 illustrates an example upsampling operation 600, in accordance with various embodiments. The upsampling operation 600 may be a deep learning operation in an upsampling layer of a DNN, such as an upsampling layer in an auxiliary layer set 432, 434, 442, or 444 in FIG. 4. The upsampling operation 600 is performed on an input tensor 610 and computes an output tensor 620. The output tensor 620 has a larger size than the input tensor 610. As shown in FIG. 6, the input tensor 610 has a size of 3×3 and the output tensor 620 has a size of 7×7.

In the upsampling operation 600, new data elements are added to the input tensor 610 to generate an output tensor 620, e.g., through a padding process. The upsampling operation 600 includes adding new data elements to edges of the input tensor 610. In some embodiments, the upsampling operation 600 may have one or more parameters indicating the number of new data elements added to the input tensor. An example of the parameters may be a padding size. For the purpose of illustration, the padding size for the upsampling operation 600 is 1. Thus, one row of new data elements is added to both the top and bottom edges of the input tensor 510. Also, one column of new data elements is added to both the left and right edges of the input tensor 510.

The upsampling operation 600 also includes adding new data elements between original activations in the input tensor 610. As shown in FIG. 6, one new data element is added between every two activations in the input tensor 610. The padding process produces a 7×7 tensor, i.e., the output tensor 620. For the purpose of illustration, the activations of the input tensor 610 are highlighted with a dotted pattern, and the new data elements added to the input tensor 610 are not highlighted. A new data element may have a value of zero. In some embodiments, the new data elements added to the input tensor 610 may have the same value. In other embodiments, the new data elements added to the input tensor 610 may have different values.

For the purpose of simplicity and illustration, the input tensor 610 and output tensor 620 are 2D tensors. In other embodiments, the input tensor 610 and output tensor 620 may be tensors with a different number of dimensions, such as 3D tensors. In some embodiments, the input tensor 610 and the output tensor 620 may represent matrices in a single channel. The upsampling operation 600 may receive tensors with multiple channels as inputs. New data elements may be added to each of the channels.

### Example Concatenation

FIG. 7 illustrates an example concatenation operation 700, in accordance with various embodiments. The concatenation operation 700 may be a deep learning operation in a concatenation layer of a DNN, such as a concatenation layer in an auxiliary layer set 432, 434, 442, or 444 in FIG. 4.

The concatenation operation 700 has three input tensors 710 (individually referred to as “input tensor 710”). The input tensors 710 may have the same dimension along the X axis and the same dimension along the Y axis. For instance, the input tensors 710 may include different numbers of channels. In the concatenation operation 700, the input tensors 710 are combined along the Z axis to create an output tensor 720. The dimension of the output tensor 720 along the Z axis may equal the sum of the dimensions of the three input tensors 710 along the Z axis.

Even though the concatenation operation 700 is a concatenation along the Z axis, the concatenation operation 700 may combine input tensor along the X axis or along the Y axis in other embodiments. Also, even though the input tensors 710 have the same dimension along the Z axis, the input tensors 710 may have different dimensions along the Z axis in other embodiments. The number of input tensor of the concatenation operation 700 may vary. For instance, the number of input tensors of the concatenation operation 700 may be different from three. In an example, the concatenation operation 700 may be performed on two input tensors. An input tensor may be a result of another deep learning operation, such as convolution, upsampling operation, pooling operation, elementwise operation, and so on.

### Example Convolution

FIG. 8 illustrates an example convolution, in accordance with various embodiments. In some embodiments, the convolution may be a convolution in a convolutional layer of a DNN, e.g., a convolutional layer 110 in FIG. 1. In other embodiments, the convolution may be converted from a convolution variant, e.g., a transposed, resized, or dilated convolution. In the embodiments of FIG. 8, the convolution can be executed on an input tensor 810 and filters 820 (individually referred to as “filter 820”). The result of the convolution is an output tensor 830. In some embodiments, the convolution is performed by a DNN accelerator. An example of the DNN accelerator may be the DNN accelerator 202 in FIG. 2.

In the embodiments of FIG. 8, the input tensor 810 includes activations (also referred to as “input activations,” “elements,” or “input elements”) arranged in a three-dimensional (3D) matrix. An input element is a data point in the input tensor 810. The input tensor 810 has a spatial size Hᵢₙ×Wᵢₙ×Cᵢₙ, where Hᵢₙ is the height of the 3D matrix (i.e., the length along the Y axis, which indicates the number of activations in a column in the 3D matrix of each input channel), Wᵢₙ is the width of the 3D matrix (i.e., the length along the X axis, which indicates the number of activations in a row in the 3D matrix of each input channel), and Cᵢₙ is the depth of the 3D matrix (i.e., the length along the Z axis, which indicates the number of input channels). For the purpose of simplicity and illustration, the input tensor 810 has a spatial size of 7×7×3, i.e., the input tensor 810 includes three input channels and each input channel has a 7×7 3D matrix. Each input element in the input tensor 810 may be represented by a (X,Y,Z) coordinate. In other embodiments, the height, width, or depth of the input tensor 810 may be different.

Each filter 820 includes weights arranged in a 3D matrix. The values of the weights may be determined through training the DNN. A filter 820 has a spatial size H_{f}×W_{f}×C_{f}, where H_{f} is the height of the filter (i.e., the length along the Y axis, which indicates the number of weights in a column in each kernel), W_{f} is the width of the filter (i.e., the length along the X axis, which indicates the number of weights in a row in each kernel), and C_{f} is the depth of the filter (i.e., the length along the Z axis, which indicates the number of channels). In some embodiments, C_{f} equals Cᵢₙ. For purpose of simplicity and illustration, each filter 820 in FIG. 8 has a spatial size of 8×3×3, i.e., the filter 820 includes 8 convolutional kernels with a spatial size of 8×3. In other embodiments, the height, width, or depth of the filter 820 may be different. The spatial size of the convolutional kernels is smaller than the spatial size of the 3D matrix of each input channel in the input tensor 810.

An activation or weight may take one or more bytes in a memory. The number of bytes for an activation or weight may depend on the data format. For example, when the activation or weight has an INT8 format, the activation takes one byte. When the activation or weight has a FP16 format, the activation or weight takes two bytes. Other data formats may be used for activations or weights.

In the convolution, each filter 820 slides across the input tensor 810 and generates a 3D matrix for an output channel in the output tensor 830. In the embodiments of FIG. 8, the 3D matrix has a spatial size of 5×5. The output tensor 830 includes activations (also referred to as “output activations,” “elements,” or “output element”) arranged in a 3D matrix. An output activation is a data point in the output tensor 830. The output tensor 830 has a spatial size Hₒᵤₜ×Wₒᵤₜ×Cₒᵤₜ, where Hₒᵤₜ is the height of the 3D matrix (i.e., the length along the Y axis, which indicates the number of output activations in a column in the 3D matrix of each output channel), Wₒᵤₜ is the width of the 3D matrix (i.e., the length along the X axis, which indicates the number of output activations in a row in the 3D matrix of each output channel), and Cₒᵤₜ is the depth of the 3D matrix (i.e., the length along the Z axis, which indicates the number of output channels). Cₒᵤₜ may equal the number of filters 820 in the convolution. Hₒᵤₜ and Wₒᵤₜ may depend on the heights and weights of the input tensor 810 and each filter 820.

As a part of the convolution, MAC operations can be performed on a 8×3×3 subtensor 815 (which is highlighted with a dotted pattern in FIG. 8) in the input tensor 810 and each filter 820. The result of the MAC operations on the subtensor 815 and one filter 820 is an output activation. In some embodiments (e.g., embodiments where the convolution is an integral convolution), an output activation may include 8 bits, e.g., one byte. In other embodiments (e.g., embodiments where the convolution is a floating-point convolution), an output activation may include more than one byte. For instance, an output element may include two bytes.

After the MAC operations on the subtensor 815 and all the filters 820 are finished, a vector 835 is produced. The vector 835 is highlighted with slashes in FIG. 8. The vector 835 includes a sequence of output activations, which are arranged along the Z axis. The output activations in the vector 835 have the same (x, y) coordinate, but the output activations correspond to different output channels and have different Z coordinates. The dimension of the vector 835 along the Z axis may equal the total number of output channels in the output tensor 830. After the vector 835 is produced, further MAC operations are performed to produce additional vectors till the output tensor 830 is produced.

In some embodiments, the MAC operations on an 8×3×3 subtensor (e.g., the subtensor 815) and a filter 820 may be performed by a plurality of PEs. One or more PEs may receive an input operand (e.g., an input operand 817 shown in FIG. 8) and a weight operand (e.g., the weight operand 827 shown in FIG. 8). The input operand 817 includes a sequence of activations having the same (x, y) coordinate but different z coordinates. The input operand 817 includes an activation from each of the input channels in the input tensor 810. The weight operand 827 includes a sequence of weights having the same (x, y) coordinate but different z coordinates. The weight operand 827 includes a weight from each of the channels in the filter 820. Activations in the input operand 817 and weights in the weight operand 827 may be sequentially fed into a PE. The PE may receive an activation and a weight (“an activation-weight pair”) at a time and multiple the activation and the weight. The position of the activation in the input operand 817 may match the position of the weight in the weight operand 827. The activation and weight may correspond to the same channel.

### Example PE Array

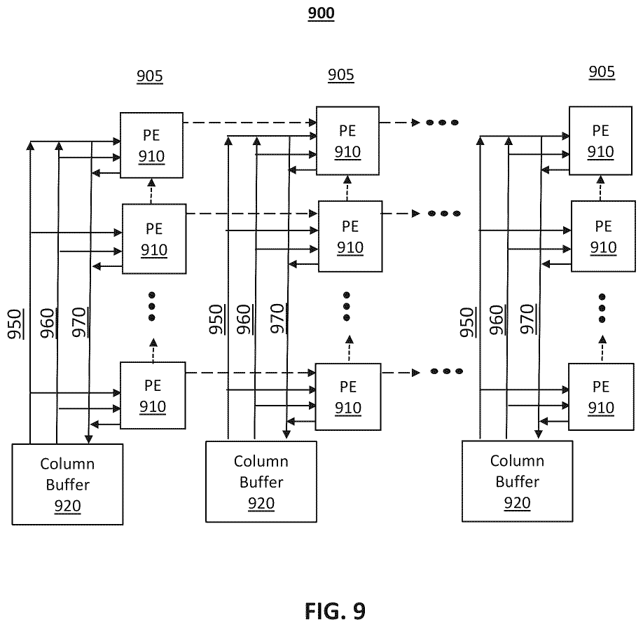

FIG. 9 illustrates an example PE array, in accordance with various embodiments. The PE array 900 may be an embodiment of the PE array 250 in FIG. 3. The PE array 900 includes a plurality of PEs 910 (individually referred to as “PE 910”). The PEs 910 can perform MAC operations, including MAC operations in quantized inference. The PEs 910 may also be referred to as neurons in the DNN. Each PE 910 has two input signals 950 and 960 and an output signal 970. The input signal 950 is at least a portion of an IFM to the layer. The input signal 960 is at least a portion of a filter of the layer. In some embodiments, the input signal 950 of a PE 910 includes one or more input operands, and the input signal 960 includes one or more weight operands.

Each PE 910 performs an MAC operation on the input signals 950 and 960 and outputs the output signal 970, which is a result of the MAC operation. Some or all of the input signals 950 and 960 and the output signal 970 may be in an integer format, such as INT8, or floating-point format, such as FP16 or BF16. For the purpose of simplicity and illustration, the input signals and output signal of all the PEs 910 have the same reference numbers, but the PEs 910 may receive different input signals and output different output signals from each other. Also, a PE 910 may be different from another PE 910, e.g., including more, fewer, or different components.

As shown in FIG. 9, the PEs 910 are connected to each other, as indicated by the dash arrows in FIG. 9. The output signal 970 of an PE 910 may be sent to many other PEs 910 (and possibly back to itself) as input signals via the interconnections between PEs 910. In some embodiments, the output signal 970 of an PE 910 may incorporate the output signals of one or more other PEs 910 through an accumulate operation of the PE 910 and generates an internal partial sum of the PE array.

In the embodiments of FIG. 9, the PEs 910 are arranged into columns 905 (individually referred to as “column 905”). The input and weights of the layer may be distributed to the PEs 910 based on the columns 905. Each column 905 has a column buffer 920. The column buffer 920 stores data provided to the PEs 910 in the column 905 for a short amount of time. The column buffer 920 may also store data output by the last PE 910 in the column 905. The output of the last PE 910 may be a sum of the MAC operations of all the PEs 910 in the column 905, which is a column-level internal partial sum of the PE array 900. In other embodiments, input and weights may be distributed to the PEs 910 based on rows in the PE array 900. The PE array 900 may include row buffers in lieu of column buffers 920. A row buffer may store input signals of the PEs in the corresponding row and may also store a row-level internal partial sum of the PE array 900.

In some embodiments, a column buffer 920 may be a portion of the local memory 240 in FIG. 3. The column buffer 920 may be associated with upper memory hierarchies, e.g., the memory 210 in FIG. 3. Data in the column buffer 920 may be sent to the upper memory hierarchies. The column buffer 920 may receive data from the upper memory hierarchies.

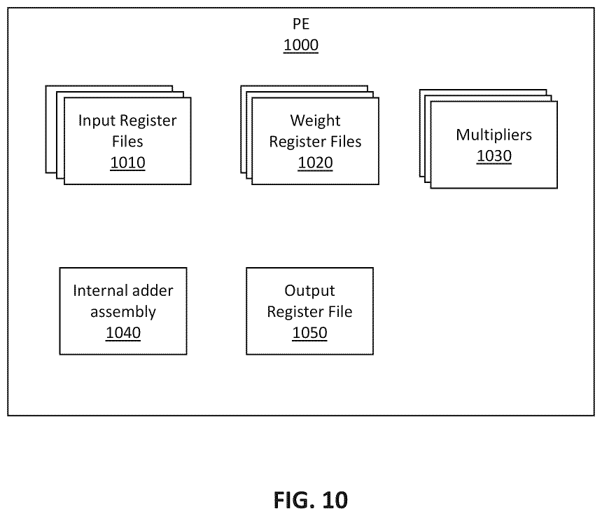

FIG. 10 is a block diagram of a PE 1000, in accordance with various embodiments. The PE 1000 may be an embodiment of the PE 910 in FIG. 9. The PE 1000 may perform MAC operations, e.g., MAC operations using data in integer formats. The PE 1000 may be an example PE in the PE array 250 described above in conjunction with FIG. 3. As shown in FIG. 10, the PE 1000 includes input register files 1010 (individually referred to as “input register file 1010”), weight registers file 1020 (individually referred to as “weight register file 1020”), multipliers 1030 (individually referred to as “multiplier 1030”), an internal adder assembly 1040, and an output register file 1050. In other embodiments, the PE 1000 may include fewer, more, or different components. For example, the PE 1000 may include multiple output register files 1050. As another example, the PE 1000 may include a single input register file 1010, weight register file 1020, or multiplier 1030. As yet another example, the PE 1000 may include an adder in lieu of the internal adder assembly 1040.

The input register files 1010 temporarily store input operands for MAC operations by the PE 1000. In some embodiments, an input register file 1010 may store a single input operand at a time. In other embodiments, an input register file 1010 may store multiple input operand or a portion of an input operand at a time. An input operand includes a plurality of input elements (i.e., input elements) in an input tensor. The input elements of an input operand may be stored sequentially in the input register file 1010 so the input elements can be processed sequentially. In some embodiments, each input element in the input operand may be from a different input channel of the input tensor. The input operand may include an input element from each of the input channels of the input tensor, and the number of input elements in an input operand may equal the number of the input channels. The input elements in an input operand may have the same (X,Y) coordinates, which may be used as the (X,Y) coordinates of the input operand. For instance, all the input elements of an input operand may be X0Y0, X0Y1, X1Y1, etc.

The weight register file 1020 temporarily stores weight operands for MAC operations by the PE 1000. The weight operands include weights in the filters of the DNN layer. In some embodiments, the weight register file 1020 may store a single weight operand at a time. other embodiments, an input register file 1010 may store multiple weight operands or a portion of a weight operand at a time. A weight operand may include a plurality of weights. The weights of a weight operand may be stored sequentially in the weight register file 1020 so the weight can be processed sequentially. In some embodiments, for a multiplication operation that involves a weight operand and an input operand, each weight in the weight operand may correspond to an input element of the input operand. The number of weights in the weight operand may equal the number of the input elements in the input operand.

In some embodiments, a weight register file 1020 may be the same or similar as an input register file 1010, e.g., having the same size, etc. The PE 1000 may include a plurality of register files, some of which are designated as the input register files 1010 for storing input operands, some of which are designated as the weight register files 1020 for storing weight operands, and some of which are designated as the output register file 1050 for storing output operands. In other embodiments, register files in the PE 1000 may be designated for other purposes, e.g., for storing scale operands used in elementwise add operations, etc.

The multipliers 1030 perform multiplication operations on input operands and weight operands. A multiplier 1030 may perform a sequence of multiplication operations on a single input operand and a single weight operand and generate a product operand including a sequence of products. Each multiplication operation in the sequence includes multiplying an input element in the input operand and a weight in the weight operand. In some embodiments, a position (or index) of the input element in the input operand matches the position (or index) of the weight in the weight operand. For instance, the first multiplication operation is a multiplication of the first input element in the input operand and the first weight in the weight operand, the second multiplication operation is a multiplication of the second input element in the input operand and the second weight in the weight operand, the third multiplication operation is a multiplication of the third input element in the input operand and the third weight in the weight operand, and so on. The input element and weight in the same multiplication operation may correspond to the same depthwise channel, and their product may also correspond to the same depthwise channel.

Multiple multipliers 1030 may perform multiplication operations simultaneously. These multiplication operations may be referred to as a round of multiplication operations. In a round of multiplication operations by the multipliers 1030, each of the multipliers 1030 may use a different input operand and a different weight operand. The different input operands or weight operands may be stored in different register files of the PE 1000. For instance, a first multiplier 1030 uses a first input operand (e.g., stored in a first input register file 1010) and a first weight operand (e.g., stored in a first weight register file 1020), versus a second multiplier 1030 uses a second input operand (e.g., stored in a second input register file 1010) and a second weight operand (e.g., stored in a second weight register file 1020), a third multiplier 1030 uses a third input operand (e.g., stored in a third input register file 1010) and a third weight operand (e.g., stored in a third weight register file 1020), and so on. For an individual multiplier 1030, the round of multiplication operations may include a plurality of cycles. A cycle includes a multiplication operation on an input element and a weight.

The multipliers 1030 may perform multiple rounds of multiplication operations. A multiplier 1030 may use the same weight operand but different input operands in different rounds. For instance, the multiplier 1030 performs a sequence of multiplication operations on a first input operand stored in a first input register file in a first round, versus a second input operand stored in a second input register file in a second round. In the second round, a different multiplier 1030 may use the first input operand and a different weight operand to perform another sequence of multiplication operations. That way, the first input operand is reused in the second round. The first input operand may be further reused in additional rounds, e.g., by additional multipliers 1030.

The internal adder assembly 1040 includes one or more adders inside the PE 1000, i.e., internal adders. The internal adder assembly 1040 may perform accumulation operations on two or more products operands from multipliers 1030 and produce an output operand of the PE 1000. In some embodiments, the internal adders are arranged in a sequence of tiers. A tier includes one or more internal adders. For the first tier of the internal adder assembly 1040, an internal adder may receive product operands from two or more multipliers 1030 and generate a sum operand through a sequence of accumulation operations. Each accumulation operation produces a sum of two or more products, each of which is from a different multiplier 1030. The sum operand includes a sequence of sums, each of which is a result of an accumulation operation and corresponds to a depthwise channel. For the other tier(s) of the internal adder assembly 1040, an internal adder in a tier receives sum operands from the precedent tier in the sequence. Each of these numbers may be generated by a different internal adder in the precedent tier. A ratio of the number of internal adders in a tier to the number of internal adders in a subsequent tier may be 2:1. In some embodiments, the last tier of the internal adder assembly 1040 may include a single internal adder, which produces the output operand of the PE 1000.

The output register file 1050 stores output operands of the PE 1000. In some embodiments, the output register file 1050 may store an output operand at a time. In other embodiments, the output register file 1050 may store multiple output operands or a portion of an output operand at a time. An output operand includes a plurality of output elements in an IFM. The output elements of an output operand may be stored sequentially in the output register file 1050 so the output elements can be processed sequentially. In some embodiments, each output element in the output operand corresponds to a different depthwise channel and is an element of a different output channel of the output channel of the depthwise convolution. The number of output elements in an output operand may equal the number of the depthwise channels of the depthwise convolution.

### Example Method of Training DNNs with Budding Ensemble Architectures

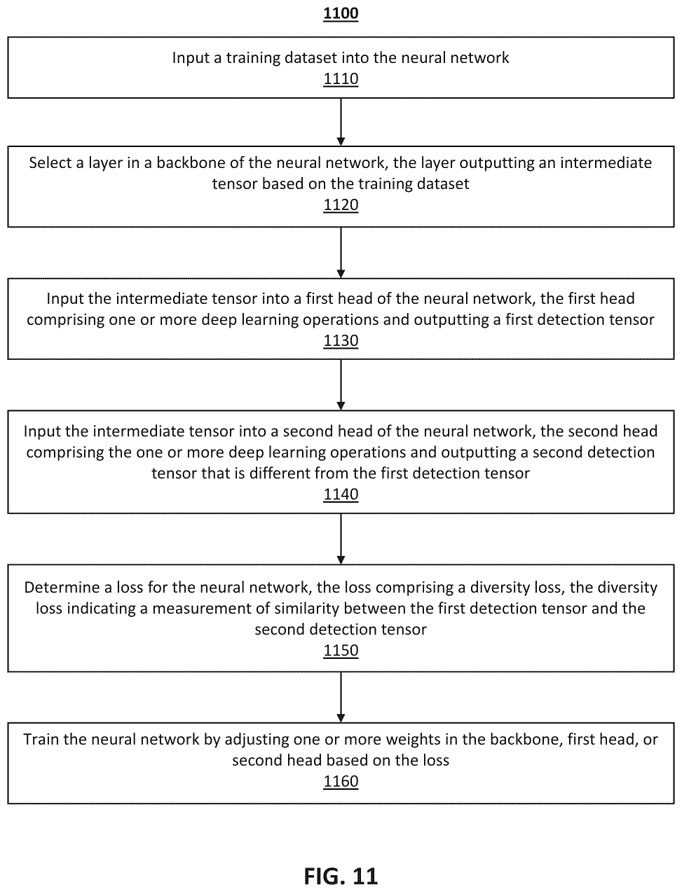

FIG. 11 is a flowchart showing a method 1100 of training DNNs with budding ensemble architectures, in accordance with various embodiments. The method 1100 may be performed by the DNN module 201 (e.g., the training module 340 in the DNN module 201) in FIG. 2 or FIG. 3. Although the method 1100 is described with reference to the flowchart illustrated in FIG. 11, many other methods for training DNNs with budding ensemble architectures may alternatively be used. For example, the order of execution of the steps in FIG. 11 may be changed. As another example, some of the steps may be changed, eliminated, or combined.

The DNN module 201 inputs 1110 a training dataset into a neural network. The neural network may be a DNN having a budding ensemble architecture. An example of the neural network is the DNN 400 in FIG. 4.

The DNN module 201 selects 1120 a layer in a backbone of the neural network. The layer outputs an intermediate tensor based on the training dataset. The intermediate tensor may be an intermediate feature map. In some embodiments, the DNN module 201 also selects another layer in the backbone of the neural network. The another layer generates another intermediate tensor based on the training dataset. In some embodiments, the another intermediate tensor has a different size from the intermediate tensor. The backbone may be coupled to a plurality of heads that can process one or more intermediate tensors computed by one or more layers in the backbone and generate detection tensors.

The DNN module 201 inputs 1130 the intermediate tensor into a first head of the neural network. The first head comprises one or more deep learning operations and outputs a first detection tensor. The first head may include one or more layers, each layer may correspond to one of the deep learning operations.

The DNN module 201 inputs 1140 the intermediate tensor into a second head of the neural network. The second head comprises the one or more deep learning operations that compute a second detection tensor that is different from the first detection tensor. The second head may be a duplication of the first head. The second head may have the same layer architecture as the first head, but at least one layer in the second head may have one or more different internal parameters (e.g., weights) from the corresponding layer in the first head.

In some embodiments, the DNN module 201 inputs the another intermediate tensor into a third head of the neural network. The third head comprises one or more other deep learning operations that compute a third detection tensor. The DNN module 201 also inputs the another intermediate tensor into a fourth head of the neural network. The fourth head comprises the one or more other deep learning operations that compute a fourth detection tensor that is different from the third detection tensor.

In some embodiments, the DNN module 201 inputs the first detection tensor into the third head. The third detection tensor is computed based on the first detection tensor and the another intermediate tensor. The DNN module 201 also inputs the second detection tensor into the fourth head. The fourth detection tensor computed based on the second detection tensor and the another intermediate tensor.

In some embodiments, the one or more other operations comprise an upsampling operation that computes an upsampled tensor by increasing one or more dimensions of the first detection tensor. In some embodiments, the one or more other operations further comprises a concatenation operation that computes a tensor by concatenating the upsampled tensor with the another intermediate tensor.

The DNN module 201 determines 1150 a loss for the neural network. The loss comprises a diversity loss. The diversity loss indicates a measurement of similarity between the first detection tensor and the second detection tensor. In some embodiments, the measurement of similarity comprises a measurement of centered kernel alignment similarity between the first detection tensor and the second detection tensor or a measurement of cosine similarity between the first detection tensor and the second detection tensor.

The DNN module 201 trains 1160 the neural network by adjusting one or more weights in the backbone, first head, or second head based on the loss. For instance, the DNN module 201 adjusts one or more weights in the backbone, first head, or second head to minimize the loss. In some embodiments, the loss further comprises another diversity loss that indicates a measurement of similarity between the third detection tensor and the fourth detection tensor.

### Example Computing Device

FIG. 12 is a block diagram of an example computing device 1200, in accordance with various embodiments. In some embodiments, the computing device 1200 can be used as at least part of the DNN system 200. A number of components are illustrated in FIG. 12 as included in the computing device 1200, but any one or more of these components may be omitted or duplicated, as suitable for the application. In some embodiments, some or all of the components included in the computing device 1200 may be attached to one or more motherboards. In some embodiments, some or all of these components are fabricated onto a single system on a chip (SoC) die. Additionally, in various embodiments, the computing device 1200 may not include one or more of the components illustrated in FIG. 12, but the computing device 1200 may include interface circuitry for coupling to the one or more components. For example, the computing device 1200 may not include a display device 1206, but may include display device interface circuitry (e.g., a connector and driver circuitry) to which a display device 1206 may be coupled. In another set of examples, the computing device 1200 may not include an audio input device 1218 or an audio output device 1208, but may include audio input or output device interface circuitry (e.g., connectors and supporting circuitry) to which an audio input device 1218 or audio output device 1208 may be coupled.

The computing device 1200 may include a processing device 1202 (e.g., one or more processing devices). The processing device 1202 processes electronic data from registers and/or memory to transform that electronic data into other electronic data that may be stored in registers and/or memory. The computing device 1200 may include a memory 1204, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 1204 may include memory that shares a die with the processing device 1202. In some embodiments, the memory 1204 includes one or more non-transitory computer-readable media storing instructions executable to perform methods or operations, e.g., the method 1100 described above in conjunction with FIG. 11 or operations performed by the DNN module 201 described above in conjunction with FIGS. 2 and 3. The instructions stored in the one or more non-transitory computer-readable media may be executed by the processing device 1202.

In some embodiments, the computing device 1200 may include a communication chip 1212 (e.g., one or more communication chips). For example, the communication chip 1212 may be configured for managing wireless communications for the transfer of data to and from the computing device 1200. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 1212 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 1212 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 1212 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1212 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1212 may operate in accordance with other wireless protocols in other embodiments. The computing device 1200 may include an antenna 1222 to facilitate wireless communications and/or to receive other wireless communications (such as AM or FM radio transmissions).

In some embodiments, the communication chip 1212 may manage wired communications, such as electrical, optical, or any other suitable communication protocols (e.g., the Ethernet). As noted above, the communication chip 1212 may include multiple communication chips. For instance, a first communication chip 1212 may be dedicated to shorter-range wireless communications such as Wi-Fi or Bluetooth, and a second communication chip 1212 may be dedicated to longer-range wireless communications such as global positioning system (GPS), EDGE, GPRS, CDMA, WiMAX, LTE, EV-DO, or others. In some embodiments, a first communication chip 1212 may be dedicated to wireless communications, and a second communication chip 1212 may be dedicated to wired communications.

The computing device 1200 may include battery/power circuitry 1214. The battery/power circuitry 1214 may include one or more energy storage devices (e.g., batteries or capacitors) and/or circuitry for coupling components of the computing device 1200 to an energy source separate from the computing device 1200 (e.g., AC line power).

The computing device 1200 may include a display device 1206 (or corresponding interface circuitry, as discussed above). The display device 1206 may include any visual indicators, such as a heads-up display, a computer monitor, a projector, a touchscreen display, a liquid crystal display (LCD), a light-emitting diode display, or a flat panel display, for example.

The computing device 1200 may include an audio output device 1208 (or corresponding interface circuitry, as discussed above). The audio output device 1208 may include any device that generates an audible indicator, such as speakers, headsets, or earbuds, for example.

The computing device 1200 may include an audio input device 1218 (or corresponding interface circuitry, as discussed above). The audio input device 1218 may include any device that generates a signal representative of a sound, such as microphones, microphone arrays, or digital instruments (e.g., instruments having a musical instrument digital interface (MIDI) output).

The computing device 1200 may include a GPS device 1216 (or corresponding interface circuitry, as discussed above). The GPS device 1216 may be in communication with a satellite-based system and may receive a location of the computing device 1200, as known in the art.

The computing device 1200 may include another output device 1210 (or corresponding interface circuitry, as discussed above). Examples of the other output device 1210 may include an audio codec, a video codec, a printer, a wired or wireless transmitter for providing information to other devices, or an additional storage device.

The computing device 1200 may include another input device 1220 (or corresponding interface circuitry, as discussed above). Examples of the other input device 1220 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1200 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 1200 may be any other electronic device that processes data.

### Select Examples

The following paragraphs provide various examples of the embodiments disclosed herein.

Example 1 provides a method of training a neural network, including: inputting a training dataset into the neural network; selecting a layer in a backbone of the neural network, the layer outputting an intermediate tensor based on the training dataset; inputting the intermediate tensor into a first head of the neural network, the first head including one or more deep learning operations and outputting a first detection tensor; inputting the intermediate tensor into a second head of the neural network, the second head including the one or more deep learning operations that compute a second detection tensor that is different from the first detection tensor; determining a loss for the neural network, the loss including a diversity loss, the diversity loss indicating a measurement of similarity between the first detection tensor and the second detection tensor; and training the neural network by adjusting one or more weights in the backbone, first head, or second head based on the loss.

Example 2 provides the method of example 1, further including: selecting another layer in the backbone of the neural network, the another layer generating another intermediate tensor based on the training dataset; inputting the another intermediate tensor into a third head of the neural network, the third head including one or more other deep learning operations that compute a third detection tensor; and inputting the another intermediate tensor into a fourth head of the neural network, the fourth head including the one or more other deep learning operations that compute a fourth detection tensor that is different from the third detection tensor, where the loss further includes another diversity loss that indicates a measurement of similarity between the third detection tensor and the fourth detection tensor.

Example 3 provides the method of example 2, where the another intermediate tensor has a different size from the intermediate tensor.

Example 4 provides the method of example 2 or 3, further including: inputting the first detection tensor into the third head, the third detection tensor computed based on the first detection tensor and the another intermediate tensor; and inputting the second detection tensor into the fourth head, the fourth detection tensor computed based on the second detection tensor and the another intermediate tensor.

Example 5 provides the method of example 4, where the one or more other operations include an upsampling operation that computes an upsampled tensor by increasing one or more dimensions of the first detection tensor.

Example 6 provides the method of example 5, where the one or more other operations further include a concatenation operation that computes a tensor by concatenating the upsampled tensor with the another intermediate tensor.

Example 7 provides the method of any one of examples 1-6, where the measurement of similarity includes a measurement of centered kernel alignment similarity between the first detection tensor and the second detection tensor or a measurement of cosine similarity between the first detection tensor and the second detection tensor.

Example 8 provides one or more non-transitory computer-readable media storing instructions executable to perform operations for training a neural network, the operations including: inputting a training dataset into the neural network; selecting a layer in a backbone of the neural network, the layer outputting an intermediate tensor based on the training dataset; inputting the intermediate tensor into a first head of the neural network, the first head including one or more deep learning operations and outputting a first detection tensor; inputting the intermediate tensor into a second head of the neural network, the second head including the one or more deep learning operations that compute a second detection tensor that is different from the first detection tensor; determining a loss for the neural network, the loss including a diversity loss, the diversity loss indicating a measurement of similarity between the first detection tensor and the second detection tensor; and training the neural network by adjusting one or more weights in the backbone, first head, or second head based on the loss.

Example 9 provides the one or more non-transitory computer-readable media of example 8, where the operations further include: selecting another layer in the backbone of the neural network, the another layer generating another intermediate tensor based on the training dataset; inputting the another intermediate tensor into a third head of the neural network, the third head including one or more other deep learning operations that compute a third detection tensor; and inputting the another intermediate tensor into a fourth head of the neural network, the fourth head including the one or more other deep learning operations that compute a fourth detection tensor that is different from the third detection tensor, where the loss further includes another diversity loss that indicates a measurement of similarity between the third detection tensor and the fourth detection tensor.

Example 10 provides the one or more non-transitory computer-readable media of example 9, where the another intermediate tensor has a different size from the intermediate tensor.

Example 11 provides the one or more non-transitory computer-readable media of example 9 or 10, where the operations further include: inputting the first detection tensor into the third head, the third detection tensor computed based on the first detection tensor and the another intermediate tensor; and inputting the second detection tensor into the fourth head, the fourth detection tensor computed based on the second detection tensor and the another intermediate tensor.

Example 12 provides the one or more non-transitory computer-readable media of example 11, where the one or more other operations include an upsampling operation that computes an upsampled tensor by increasing one or more dimensions of the first detection tensor.

Example 13 provides the one or more non-transitory computer-readable media of example 12, where the one or more other operations further include a concatenation operation that computes a tensor by concatenating the upsampled tensor with the another intermediate tensor.

Example 14 provides the one or more non-transitory computer-readable media of any one of examples 8-13, where the measurement of similarity includes a measurement of centered kernel alignment similarity between the first detection tensor and the second detection tensor or a measurement of cosine similarity between the first detection tensor and the second detection tensor.

Example 15 provides an apparatus, including: a computer processor for executing computer program instructions; and a non-transitory computer-readable memory storing computer program instructions executable by the computer processor to perform operations for training a neural network, the operations including: inputting a training dataset into the neural network, selecting a layer in a backbone of the neural network, the layer outputting an intermediate tensor based on the training dataset, inputting the intermediate tensor into a first head of the neural network, the first head including one or more deep learning operations and outputting a first detection tensor, inputting the intermediate tensor into a second head of the neural network, the second head including the one or more deep learning operations that compute a second detection tensor that is different from the first detection tensor, determining a loss for the neural network, the loss including a diversity loss, the diversity loss indicating a measurement of similarity between the first detection tensor and the second detection tensor, and training the neural network by adjusting one or more weights in the backbone, first head, or second head based on the loss.

Example 16 provides the apparatus of example 15, where the operations further include: selecting another layer in the backbone of the neural network, the another layer generating another intermediate tensor based on the training dataset; inputting the another intermediate tensor into a third head of the neural network, the third head including one or more other deep learning operations that compute a third detection tensor; and inputting the another intermediate tensor into a fourth head of the neural network, the fourth head including the one or more other deep learning operations that compute a fourth detection tensor that is different from the third detection tensor,
where the loss further includes another diversity loss that indicates a measurement of similarity between the third detection tensor and the fourth detection tensor.

Example 17 provides the apparatus of example 16, where the operations further include: inputting the first detection tensor into the third head, the third detection tensor computed based on the first detection tensor and the another intermediate tensor; and inputting the second detection tensor into the fourth head, the fourth detection tensor computed based on the second detection tensor and the another intermediate tensor.

Example 18 provides the apparatus of example 17, where the one or more other operations include an upsampling operation that computes an upsampled tensor by increasing one or more dimensions of the first detection tensor.

Example 19 provides the apparatus of example 18, where the one or more other operations further include a concatenation operation that computes a tensor by concatenating the upsampled tensor with the another intermediate tensor.

Example 20 provides the apparatus of any one of examples 15-19, where the measurement of similarity includes a measurement of centered kernel alignment similarity between the first detection tensor and the second detection tensor or a measurement of cosine similarity between the first detection tensor and the second detection tensor.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A method of training a neural network, comprising:
inputting a training dataset into the neural network;
selecting a layer in a backbone of the neural network, the layer outputting an intermediate tensor based on the training dataset;
inputting the intermediate tensor into a first head of the neural network, the first head comprising one or more deep learning operations that compute a first detection tensor;
inputting the intermediate tensor into a second head of the neural network, the second head comprising the one or more deep learning operations that compute a second detection tensor that is different from the first detection tensor;
determining a loss for the neural network, the loss comprising a diversity loss, the diversity loss indicating a measurement of similarity between the first detection tensor and the second detection tensor; and
training the neural network by adjusting one or more weights in the backbone, first head, or second head based on the loss.

2. The method of claim 1, further comprising:
selecting another layer in the backbone of the neural network, the another layer generating another intermediate tensor based on the training dataset;
inputting the another intermediate tensor into a third head of the neural network, the third head comprising one or more other deep learning operations that compute a third detection tensor; and
inputting the another intermediate tensor into a fourth head of the neural network, the fourth head comprising the one or more other deep learning operations that compute a fourth detection tensor that is different from the third detection tensor,
wherein the loss further comprises another diversity loss that indicates a measurement of similarity between the third detection tensor and the fourth detection tensor.

3. The method of claim 2, wherein the another intermediate tensor has a different size from the intermediate tensor.

4. The method of claim 2, further comprising:
inputting the first detection tensor into the third head, the third detection tensor computed based on the first detection tensor and the another intermediate tensor; and
inputting the second detection tensor into the fourth head, the fourth detection tensor computed based on the second detection tensor and the another intermediate tensor.

5. The method of claim 4, wherein the one or more other operations comprise an upsampling operation that computes an upsampled tensor by increasing one or more dimensions of the first detection tensor.

6. The method of claim 5, wherein the one or more other operations further comprise a concatenation operation that computes a tensor by concatenating the upsampled tensor with the another intermediate tensor.

7. The method of claim 1, wherein the measurement of similarity comprises a measurement of centered kernel alignment similarity between the first detection tensor and the second detection tensor or a measurement of cosine similarity between the first detection tensor and the second detection tensor.

8. One or more non-transitory computer-readable media storing instructions executable to perform operations for training a neural network, the operations comprising:
inputting a training dataset into the neural network;
selecting a layer in a backbone of the neural network, the layer outputting an intermediate tensor based on the training dataset;
inputting the intermediate tensor into a first head of the neural network, the first head comprising one or more deep learning operations that compute a first detection tensor;
inputting the intermediate tensor into a second head of the neural network, the second head comprising the one or more deep learning operations that compute a second detection tensor that is different from the first detection tensor;
determining a loss for the neural network, the loss comprising a diversity loss, the diversity loss indicating a measurement of similarity between the first detection tensor and the second detection tensor; and
training the neural network by adjusting one or more weights in the backbone, first head, or second head based on the loss.

9. The one or more non-transitory computer-readable media of claim 8, wherein the operations further comprise:
selecting another layer in the backbone of the neural network, the another layer generating another intermediate tensor based on the training dataset;
inputting the another intermediate tensor into a third head of the neural network, the third head comprising one or more other deep learning operations that compute a third detection tensor; and
inputting the another intermediate tensor into a fourth head of the neural network, the fourth head comprising the one or more other deep learning operations that compute a fourth detection tensor that is different from the third detection tensor,
wherein the loss further comprises another diversity loss that indicates a measurement of similarity between the third detection tensor and the fourth detection tensor.

10. The one or more non-transitory computer-readable media of claim 9, wherein the another intermediate tensor has a different size from the intermediate tensor.

11. The one or more non-transitory computer-readable media of claim 9, wherein the operations further comprise:
inputting the first detection tensor into the third head, the third detection tensor computed based on the first detection tensor and the another intermediate tensor; and
inputting the second detection tensor into the fourth head, the fourth detection tensor computed based on the second detection tensor and the another intermediate tensor.

12. The one or more non-transitory computer-readable media of claim 11, wherein the one or more other operations comprise an upsampling operation that computes an upsampled tensor by increasing one or more dimensions of the first detection tensor.

13. The one or more non-transitory computer-readable media of claim 12, wherein the one or more other operations further comprise a concatenation operation that computes a tensor by concatenating the upsampled tensor with the another intermediate tensor.

14. The one or more non-transitory computer-readable media of claim 8, wherein the measurement of similarity comprises a measurement of centered kernel alignment similarity between the first detection tensor and the second detection tensor or a measurement of cosine similarity between the first detection tensor and the second detection tensor.

15. An apparatus, comprising:
a computer processor for executing computer program instructions; and
a non-transitory computer-readable memory storing computer program instructions executable by the computer processor to perform operations for training a neural network, the operations comprising:
inputting a training dataset into the neural network,
selecting a layer in a backbone of the neural network, the layer outputting an intermediate tensor based on the training dataset,
inputting the intermediate tensor into a first head of the neural network, the first head comprising one or more deep learning operations that compute a first detection tensor,
inputting the intermediate tensor into a second head of the neural network, the second head comprising the one or more deep learning operations that compute a second detection tensor that is different from the first detection tensor,
determining a loss for the neural network, the loss comprising a diversity loss, the diversity loss indicating a measurement of similarity between the first detection tensor and the second detection tensor, and
training the neural network by adjusting one or more weights in the backbone, first head, or second head based on the loss.

16. The apparatus of claim 15, wherein the operations further comprise:
selecting another layer in the backbone of the neural network, the another layer generating another intermediate tensor based on the training dataset;
inputting the another intermediate tensor into a third head of the neural network, the third head comprising one or more other deep learning operations that compute a third detection tensor; and
inputting the another intermediate tensor into a fourth head of the neural network, the fourth head comprising the one or more other deep learning operations that compute a fourth detection tensor that is different from the third detection tensor,
wherein the loss further comprises another diversity loss that indicates a measurement of similarity between the third detection tensor and the fourth detection tensor.

17. The apparatus of claim 16, wherein the operations further comprise:
inputting the first detection tensor into the third head, the third detection tensor computed based on the first detection tensor and the another intermediate tensor; and
inputting the second detection tensor into the fourth head, the fourth detection tensor computed based on the second detection tensor and the another intermediate tensor.

18. The apparatus of claim 17, wherein the one or more other operations comprise an upsampling operation that computes an upsampled tensor by increasing one or more dimensions of the first detection tensor.

19. The apparatus of claim 18, wherein the one or more other operations further comprise a concatenation operation that computes a tensor by concatenating the upsampled tensor with the another intermediate tensor.

20. The apparatus of claim 15, wherein the measurement of similarity comprises a measurement of centered kernel alignment similarity between the first detection tensor and the second detection tensor or a measurement of cosine similarity between the first detection tensor and the second detection tensor.
